(19) United States
(12) Patent Application Publication
(10) Pub. No.: US 2003/0093351 A1
(43) Pub. Date: May 15, 2003

(54) Method and system for valuation of financial instruments

(76) Inventor: Alvin Sarabanchong, Manhasset Hills, NY (US)

Correspondence Address: PILLSBURY WINTHROP, LLP, P.O. BOX 10500, MCLEAN, VA, 22102, US

(21) Appl. No.: 10/270,138

(22) Filed: Oct. 15, 2002

Related U.S. Application Data
(60) Provisional application No. 60/331,381, filed on Nov. 14, 2001.

(51) Int. Cl. G06F 17/60

(52) U.S. Cl. 705/36

(57) ABSTRACT

A fixed rate investment value modeling system and method are provided to calculate the current price or market value of a fixed rate investment, such as a Certificate of Deposit, based on instrument-specific data provided to the system and market-specific data provided to the system.

This application claims priority to U.S. Provisional Application No. 60/331,381 filed Nov. 14, 2001, entitled “Method and System for Valuation of Certificates of Deposit.”

This disclosure includes a Computer Program Listing Appendix on one compact disc labeled Disc 1, including file “ALVINCD formulas.pdf” created Apr. 29, 2002, size 31.8 KB, the entire contents of which are hereby incorporated by reference as if set forth fully herein.

This disclosure contains information subject to copyright protection. The copyright owner has no objection to the facsimile reproduction by anyone of the patent disclosure or the patent as it appears in the U.S. Patent and Trademark Office files or records, but otherwise reserves all copyright rights whatsoever.

### BACKGROUND OF THE INVENTION

1. Field of the Invention

Embodiments of the present invention relate generally to financial asset management and more particularly to determining values associated with financial instruments.

2. Description of Related Art

Financial instruments such as Certificate of Deposits (CDs) are issued by banks and savings associations that typically pay interest at specified periods of time, with principal returned at maturity. CDs are usually issued at par and are available in various denominations and maturities. A CD typically pays its owner a higher interest rate when the owner deposits it for a length of time. CDs appeal primarily to individual investors, but may, in special circumstances (e.g., pension plans), be an appropriate instrument for sophisticated financial managers. Like Treasury bills, CDs with maturities of 12 months or shorter pay both principal and interest at maturity. For CDs with maturities longer than 12 months, interest is usually paid monthly or semi-annually. Additionally, CDs are typically federally insured up to $100,000 of aggregate principal and accrued interest for all deposits held in the same legal capacity at the same depository institution. Different types of CDs include: Fixed Rate Interest Bearing CDs, Callable CDs, Step-Rate Callable CDs, and Zero Coupon CDs.

CDs have a price, or market value, associated with them at any given time. However, calculating this value is time and labor intensive requiring manual computation by financial advisors based on many different variables, the values of which are continuously changing. The current CD price or market value is useful to investors and their financial advisors in ascertaining investor positions for investment portfolio planning and tracking.

### SUMMARY OF THE INVENTION

In accordance with at least one embodiment of the invention, a financial instrument value modeling system and method are provided that calculate the current price or market value of a financial instrument based on instrument-specific data provided to the system and market-specific data provided to the system.

In particular, embodiments of a financial instrument value modeling system may include a processor configured to perform financial instrument valuation analysis based on instrument-specific data and instrument market-specific data, a memory coupled to the processor and configured to store at least instructions accessed by the processor during financial instrument valuation analysis, a system interface configured to optionally receive instrument market-specific data and provide the instrument-specific data to the processor prior to or during the financial instrument valuation analysis, and a user interface configured to receive financial instrument-specific data and provide that data to the processor prior to or during the financial instrument valuation analysis and configured to optionally receive instrument market-specific data and provide the market-specific data to the processor prior to or during the instrument valuation analysis. In certain of these embodiments, the financial instrument may be a certificate of deposit. In addition, the processor may be further configured to perform valuation analysis using a recursive algorithm, such as, but not limited to, the Black-Karasinski equations. The processor may be further configured to produce at least one valuation report.

Embodiments of a certificate of deposit value modeling method for calculating the current or future value of a certificate of deposit based on certificate-specific data and certificate market-specific data may include receiving certificate market-specific data either from a user interface or a system interface, receiving certificate of deposit-specific data from a user interface, performing certificate of deposit valuation analysis based on the certificate-specific data and the certificate market-specific data, generating certificate of deposit valuation data based on the certificate of deposit valuation analysis, and outputting the certificate of deposit valuation data via the user interface. In certain of these embodiments, the method may include a recursive algorithm for performing the valuation analysis. This recursive algorithm may include an algorithm such as, but not limited to, the Black-Karasinski equations. Outputting may further include producing at least one valuation report.

### BRIEF DESCRIPTION OF THE DRAWINGS

The benefits of the present invention will be readily appreciated and understood from consideration of the following detailed description of at least one exemplary embodiment of this invention, when taken with the accompanying drawings, in which same numbered elements are identical and:

FIG. 1 is an illustrative block diagram of a system implementing or employed by the financial instrument value modeling system in accordance with at least one of the exemplary embodiments of the invention;

FIG. 2 illustrates an implementation of a system designed in accordance with at least one embodiment;

FIG. 3 is a functional block diagram of an investment valuation module in accordance with at least one embodiment;

FIG. 4 is a flow chart illustrating processes for maintaining a financial instrument value modeling system designed in accordance with at least one exemplary embodiments of the invention;

FIG. 5 illustrates a process for entering market data on a first worksheet entitled “Valuation Model Assumptions”;

FIG. 6 illustrates one method for running the model and value financial instruments in accordance with at least one embodiment of the invention;

FIG. 7 is an example of an input data file used by a system and method designed in accordance with at least one of the embodiments of the invention;

FIG. 8 is an example of a first worksheet entitled “Valuation Model Assumptions” utilized in conjunction with at least one embodiment of the invention;

FIG. 9 is an example of a Text Import Wizard window utilized in conjunction with at least one embodiment of the invention;

FIG. 10 is an example of another Text Import Wizard window utilized in conjunction with at least one embodiment of the invention;

FIG. 11 is an example of yet another Text Import Wizard window utilized in conjunction with at least one embodiment of the invention;

FIG. 12 is an example of all in rate data that may be utilized by a system designed in accordance with at least one embodiment of the invention;

FIG. 13 is a flow chart illustrating at least one embodiment of the method having automated portions;

FIG. 14 is an example of a pricing summary report provided by at least one embodiment;

FIG. 15a is a first portion of an example security detail pricing page provided by at least one embodiment;

FIG. 15b is a second portion of an example security detail pricing page provided by at least one embodiment;

FIG. 16 is a first example of an output valuation report provided by at least one embodiment;

FIG. 17 is a second example of an output valuation report provided by at least one embodiment; and

FIG. 18 is a third example of an output valuation report provided by at least one embodiment.

### DETAILED DESCRIPTION OF THE EMBODIMENTS

While the present invention will hereinafter be described in connection with various embodiments thereof, it will be understood that it is not intended to limit the invention to those embodiments. On the contrary, it is intended to cover all alternatives, modifications and equivalents as may be included within the spirit and scope of the invention as defined by the appended claims.

In accordance with at least one embodiment of the invention, a financial instrument valuation model is implemented using and by a method and system. The at least one embodiment of the present system and method may utilize a computer-based valuation model, which primarily values financial instruments such as CDs or other interest-bearing instruments. In at least one computer-based embodiment, the system and method may utilize a spreadsheet-based valuation model. In various embodiments, one or more portions of the methods described herein may be fully or partially automated using a computer executing a sequence of programmed instructions.

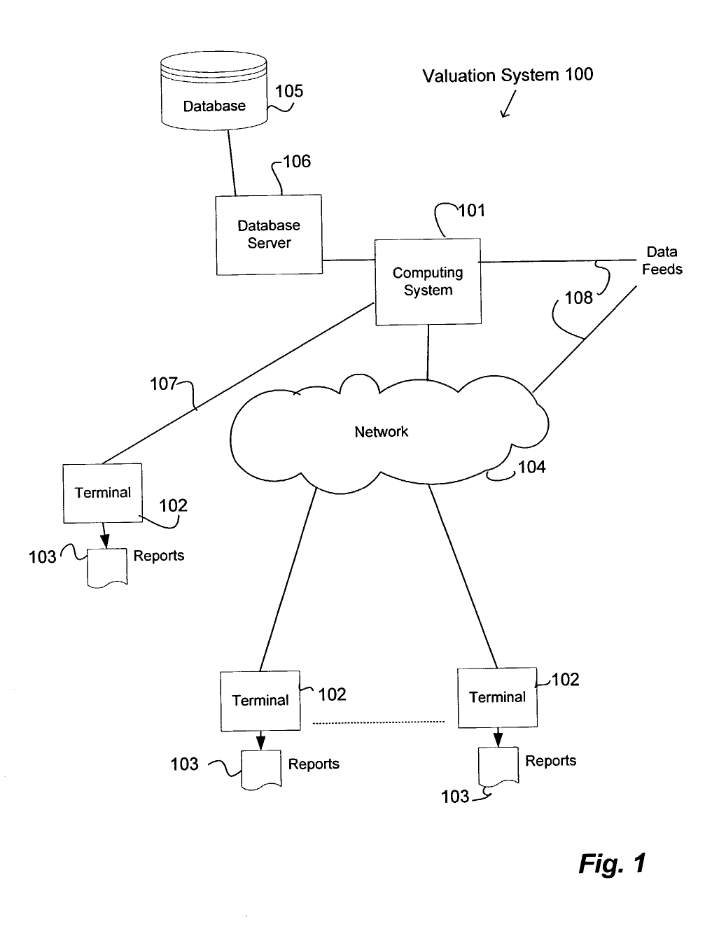

FIG. 1 is a functional block diagram of an investment valuation system 100 in accordance with at least one embodiment of the present invention. Referring now to FIG. 1, the investment valuation system 100 may include a computing system 101. In at least one embodiment, investment valuation system 100 may further include a database 105 and one or more terminals 102. In an embodiment having one or more terminals 102, computing device 101 may be electronically coupled to each of the terminals 102 using a dedicated link 107 or using a network 104. The dedicated electronic link 107 may be a dial-up telephone line (which may be a dedicated leased line) connection using a modem and enabling communications software. The network 104 used to link the computing system 101 and terminals 102 may be implemented as or include, one or more public and/or private networks, e.g., the Internet, an intranet, a Local Area Network (LAN), and Wide Area Network (WAN), or any combination thereof.

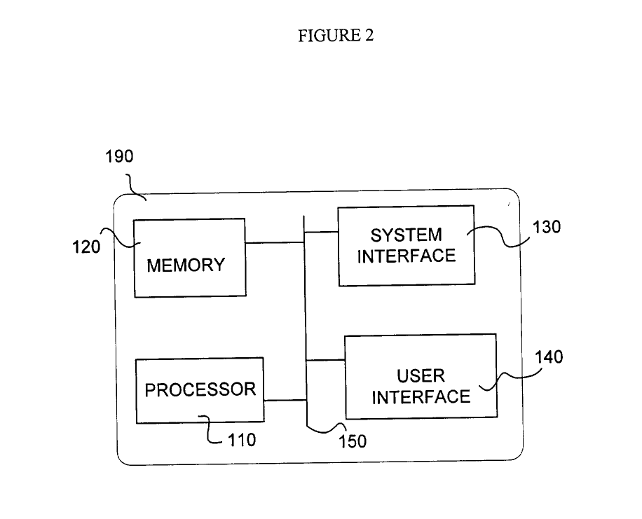

The computing system 101 and the terminal 102 may be implemented using computing equipment 190. FIG. 2 illustrates equipment 190 that may be used to implement a system designed in accordance with at least one embodiment of the invention. As shown in FIG. 2, the equipment 190 may include a processor 110, a memory 120, a system interface 130, a user interface 140 and a communication/data/control bus 150 that couples elements 110-140 together and allows for cooperation and communication between those elements. Computing equipment 190 may be implemented as or include one or more personal computers, workstations, handheld personal data assistants, Internet appliances (i.e., a computer with minimal memory, disk storage and processing power designed to connect to a network, especially the Internet), or controllers.

The memory 120 may be implemented utilizing alternative configurations depending on the needs of a user or a system associated with the financial instrument value modeling system.

The system interface 130 may include both hardware and software to allow the equipment 190 to communicate with components that provide data utilized by the investment valuation system 100, for example, data feeds providing instrument market-specific data such as financial data, interest rates, risk and return data, financial instrument types, etc., or utilize data provided by the investment valuation system 100, for example, systems for providing, managing, trading or analyzing financial instrument valuation data, e.g., electronic mail programs, financial management software, trading platforms or financial portfolio management software (each of which being potentially installed on a network also including the financial instrument value modeling system). Further, the system interface 130 may include a communication interface that is configured to provide a two-way data communication coupling to the data feeds 108 and the network 104. For example, the communication interface may be a modem or an Integrated Services Digital Network (ISDN) card to provide a data communication connection to a corresponding type of telephone line. As another example, the communication interface may be a Local Area Network (LAN) card to provide a data communication connection to a compatible LAN. Wireless links may also be implemented. In any such implementation, the communication interface sends and receives electrical, electromagnetic, or optical signals that carry digital data streams representing various types of data.

In at least one other embodiment, communications interface 225 may include an Ethernet interface or a LAN communication card, a dial-up modem interface using the Public Switched Telecommunication Network (PSTN), the Intranet, or any combination thereof.

The processor 110 controls operation of the other elements 120-150, based on instructions fetched from the memory 120. The instructions may include or be implemented as software code that dictates some or all of the operations of the financial instrument value modeling system and method of the investment valuation system 100 explained herein. The memory 120 may include this code and may also include storage area for data utilized by or generated by the financial instrument value modeling system. The processor 110 may fetch the instructions, decode them, and act or instruct other elements 120-150 to, for example, transfer data to or from the memory 120 or to work in combination with the system interface 130 or the user interface 140 (for example, to input or output data), etc.

The processor 110 may actually be implemented as more than one processor. The processor 110 may, based on instructions fetched from the memory 120, operate to control operation of the other elements 120-150. It should be appreciated that the processor 110 may be implemented as, for example, a central processing unit, microprocessor, or other similar device. Similarly, the processor 110 and the memory 120 may be implemented via one or more servers coupled to a network that allows the user interface 140 to be implemented at a user terminal and include a Graphical User Interface (GUI) on a terminal screen or other output device.

The user interface 140 may include, for example, hardware and software for cooperating with a terminal display (not shown), a data entry device such as a keyboard, and a pointing device such as a mouse. The display may be a Cathode Ray Tube (CRT) computer display monitor capable of displaying data using multiple colors. Alternatively, the display may be, for example, a liquid crystal display or a monochrome monitor. The data entry device, including alphanumeric and other keys, may be coupled to the bus 140 via the user interface portion 140 for communicating data and command selections to the processor 110. The pointing device, which may be a computer mouse, trackball, cursor direction keypad, tactile directional fingerpad, or other such device for allowing a user to control cursor location and movement on the display, and for communicating direction data and command selections to the processor. This pointing device typically has two degrees of freedom in two axes, a first axis (e.g., x) and a second axis (e.g., y), that allows the pointing device to specify positions in a plane. Moreover, the user interface 140 may include a speaker and microphone, not shown, for outputting and/or inputting data to and from a user. The user interface 140 may operate in conjunction with the processor 110 to allow a user to interact with software programs stored in the memory 120 and used by the processor 110 so as to perform the operations.

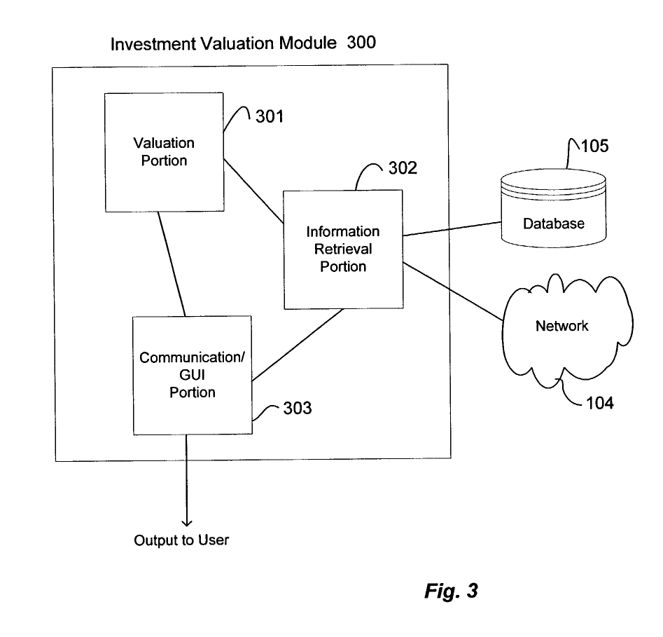

The computing system 101 may further include an investment valuation module 300 that includes a sequence of programmed instructions designed to cause the processor 110 to carry out the operations described herein. FIG. 3 is a functional block diagram of the investment valuation module 300 in accordance with at least one embodiment. As shown in FIG. 3, the investment valuation module 300 may include a valuation portion 301, an information retrieval portion 302, and a communication/GUI portion 303. In at least one embodiment, the valuation portion 301 may include instructions that cause the processor 110 to perform the pricing and valuation calculations described herein, including Black-Karasinski modeling according to a tetranomial lattice model, explained below. In at least one embodiment, the valuation portion 301 may be implemented as a sequence of instructions, including cell formulas, for execution using the Microsoft® Excel™ spreadsheet application. The valuation portion 301 may effect a recalculation of certain cell data for one or more spreadsheet pages according to a sequence of formulas implementing a recursive pricing model. For example, the valuation portion 301 may be implemented using programmed instructions in accordance with the C++, Visual Basic™, or Javascript programming languages, or any combination thereof.

The data retrieval portion 302 may include a sequence of programmed instructions for obtaining current market data required for pricing calculations performed by the valuation portion 301. In at least one embodiment, the data retrieval portion 302 may receive investment data, such as, but not limited to, investment market-specific data, from one or more data feeds 108 over a communications link. In at least one embodiment, the data retrieval portion 301 may receive current rate data including, for example, the one-year Constant Maturity Treasury (CMT) rate, brokered financial instrument program weekly indicative rates, the London InterBank Offered Rate (LIBOR) rates for maturities one (1) year and shorter, and the U.S. swap rates for fixed income investments having maturities two (2) years and greater. The data feeds 108 may be received as electronic mail messages formatted in accordance with the Simple Mail Transfer Protocol (SMTP) standard, interactive pages formatted in accordance with the Hypertext Transfer Markup Language (HTML) or eXtensible Markup Language (XML) standard, input files formatted in accordance with the File Transfer Protocol (FTP), live “wire” type electronic ticker feeds, or formatted according to a source-proprietary format and protocol. Investment data may be received using network 104. The received investment data may be made available to the valuation portion 301 for processing by the processor 110 upon request.

In embodiments including the database 105, the data retrieval portion 302 may include sequences of database access scripts to effect storage and retrieval of investment data using the database 105. These database access scripts may be implemented in the form of Structured Query Language (SQL) scripts as described elsewhere herein. In at least these embodiments, the data retrieval portion 302 may be executed by the processor 110 (and stored in the memory 120) of the computing equipment 190 of the computing system 101 configured as either a stand-alone computing platform or a server system implementation of the investment valuation system 100. In at least these embodiments, the computing system 101 may further function as the database server 106. Alternatively, the database server 106 may be implemented using one or more separate items of computing equipment 190 coupled between the computing system 101 and the database 105.

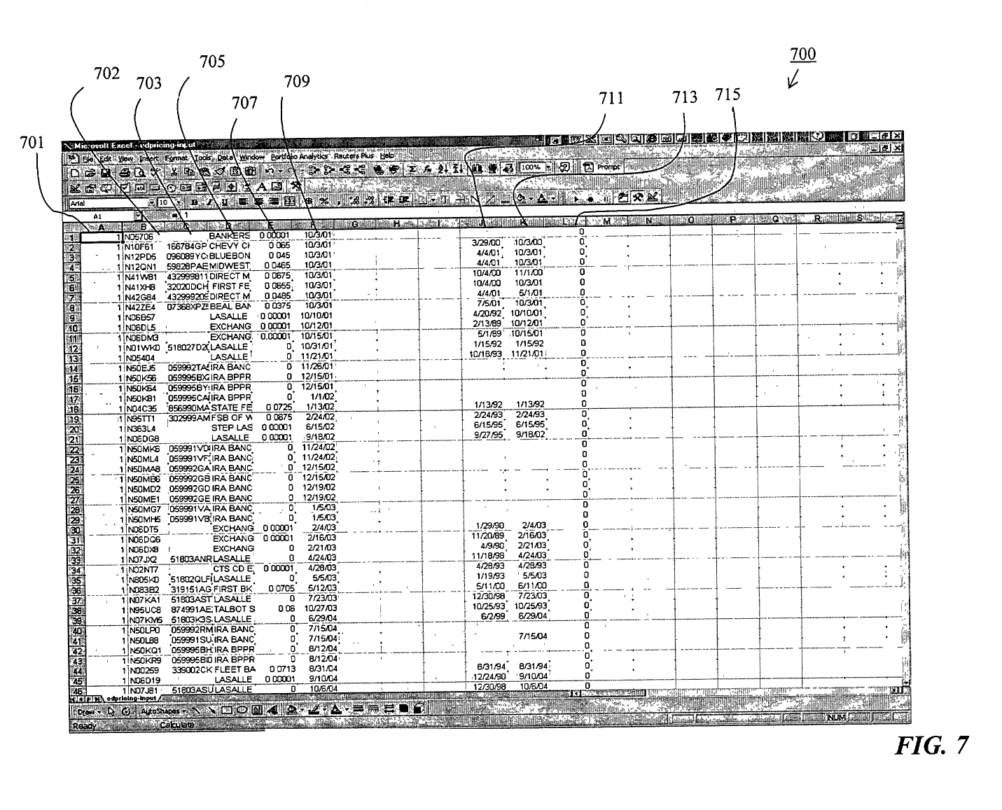

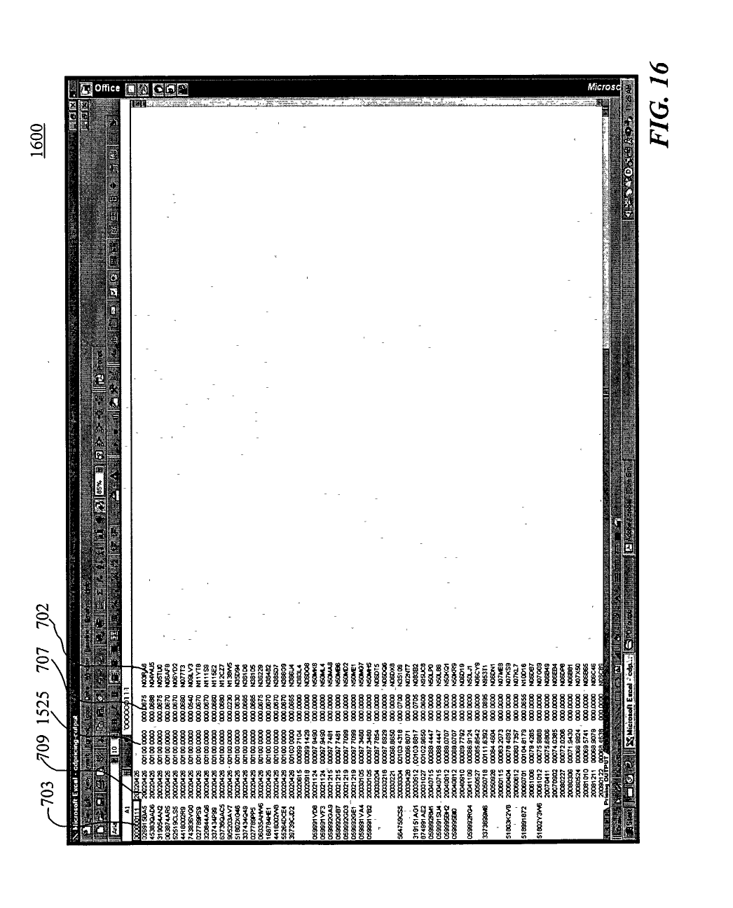

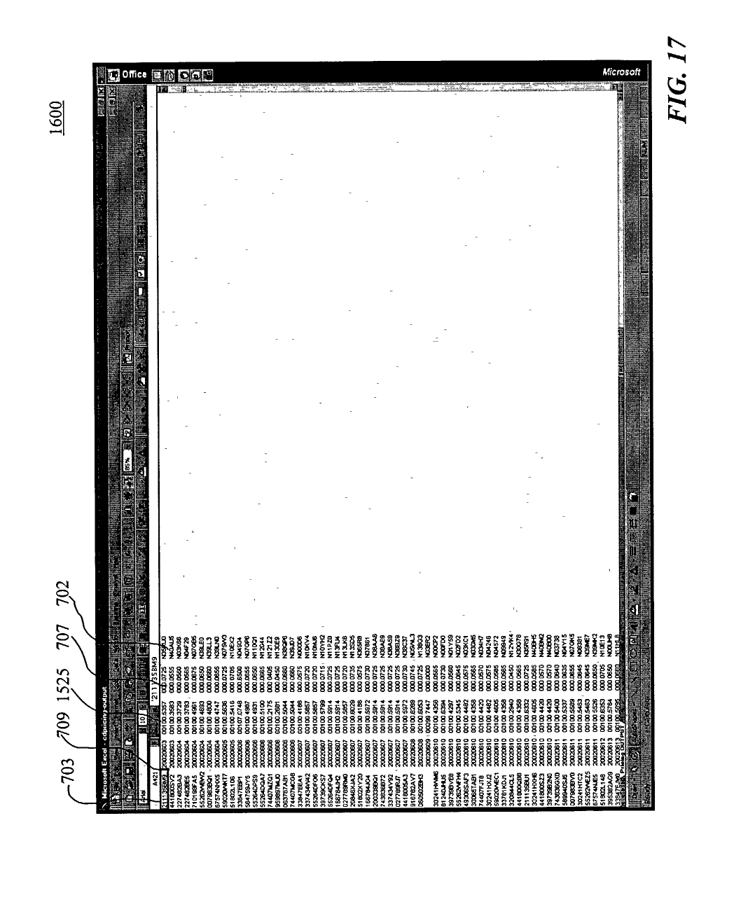

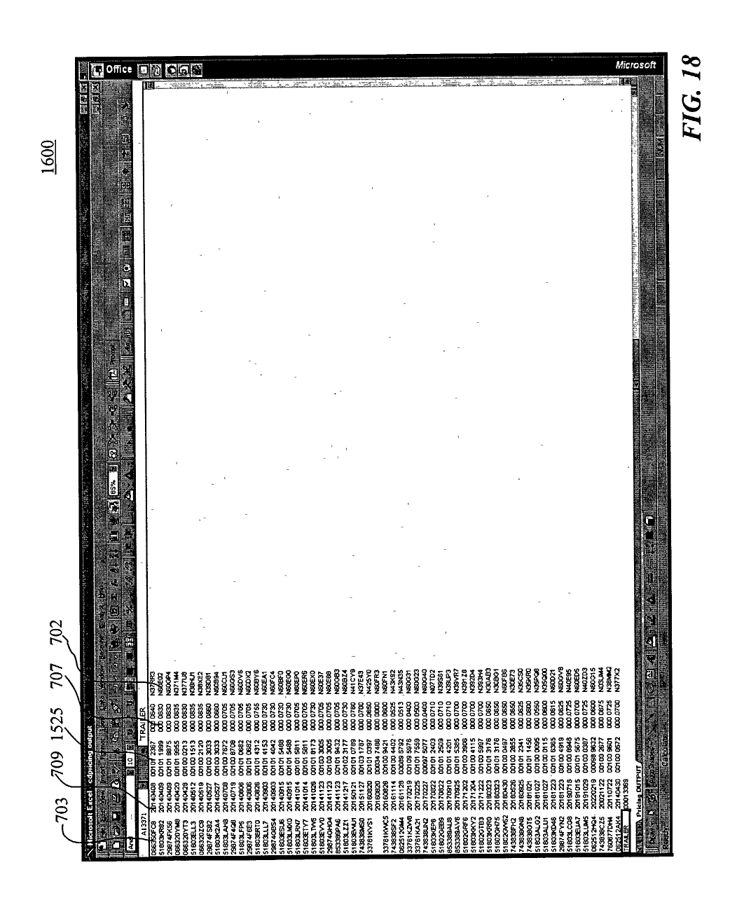

The communications/GUI portion 303 may include a sequence of programmed instructions for receiving user requests and input and for generating interactive output pages. In at least one embodiment, user input may be received by the communications/GUI portion 303 of the investment valuation system 100 as data entered into a data entry field of an interactive page, such as, but not limited to, an Excel™ spreadsheet, a browser page, or a world wide web page. User input from the pages may provide instrument specific data and instrument market-specific data to the investment valuation system 100 for use in calculating financial instrument valuation and pricing. Examples of such input pages include FIGS. 7 through 12. The communications/GUI portion 303 may output interactive pages, which in at least one embodiment, may be one or more Excel™ spreadsheets, browser formatted pages, or world wide web pages. The output interactive pages may provide to the user the results of the financial instrument valuation determined by the investment valuation system 100. For example, FIGS. 16-18 show exemplary Excel™ output pages including the calculated valuation for a certificate of deposit instrument produced by at least one embodiment of the investment valuation system 100.

The investment valuation system 100 can be implemented, for example, as portions of a suitably programmed general-purpose computer. The system may be implemented, for example, as physically distinct hardware circuits within an ASIC. Thus, it should be appreciated that the particular form of the system can be different from that explained herein.

In at least one embodiment, the computing system 101 may be a standalone computer platform according to the computing equipment 190 and having its own associated output device. The output device may be a computer display monitor. In these embodiments, the application program 300 may be implemented as a sequence of programmed instructions for execution by the processor 110. In at least one of these embodiments, the valuation portion 301 may be implemented as a sequence of instructions, including cell formulas, for execution using the Microsoft® Excel™ spreadsheet application present at the computing equipment 190. The computing system 101 may provide one or more valuation reports 103 as an Excel™ spreadsheet page in the form of a .xls file or as a hardcopy printout in the form of a .prn file.

Although the above-described embodiments of the investment valuation system 100 have been described as being implementable on a general-purpose computer, for example, a personal computer, it is foreseeable that the system may be implemented in a network environment wherein software implementing the system is stored on one or more servers.

For example, in at least one embodiment as shown in FIG. 1, computing system 101 may be a server system. In these embodiments, the computing system 101 server may include one or more application programs that, when executed by the computing system 101, cause the computing system 101 server to output interactive display screens to users at the terminals 102 upon user request. The interactive display screens may be provided to the requesting terminal 102 in accordance with a markup language standard permitting user selection of interactive links using a pointing device.

In at least one embodiment, the computing system 101 server may be implemented using a single hardware and software computing platform, such as a Sun workstation™ available from Sun Microsystems of Palo Alto, Calif. In other embodiments, the computing system 101 server may be implemented across multiple such computing platforms. In addition, the database server 106 and the computing system 101 server may both be implemented using the same computing platform.

The database 105 may be, for example, a SQL database provided by the Oracle Corporation of Redwood Shores, Calif. Alternatively, the database 105 may be a SQL Server 7.0 database supporting the ActiveX Data Object (ADO) and Open DataBase Connectivity (ODBC) protocols provided by IBM Corporation or Sybase Corporation. The database 105 may include data including, but not limited to, database query and access instructions in the form of one or more scripts which, when executed by a processor such as the processor 110, serve to store and retrieve data maintained using the database 105 according to the instructions contained in the script, and in particular regarding the data fields to be accessed, as well as their arrangement, provided in the response to the processor 110.

The terminal 102 may be a personal computer with a browser, such as a World Wide Web browser application. Alternatively, the terminal 102 may be, for example, a PC, a wireless terminal such as a personal digital assistant, a cellular or portable telephone terminal, or an Internet appliance.

According to at least one embodiment, valuation and modeling of pricing data in the manner described herein may be provided by the computing system 101 in response to the processor 110 executing one or more sequences of instructions contained in memory 120. Such instructions may be read into the memory 120 from another computer-readable medium, such as a storage device or a database. Execution of the sequences of instructions contained in the memory 120 may cause the processor 110 to perform the process steps described herein. One or more processors in a multi-processing arrangement may also be employed to execute the sequences of instructions contained in the memory 120. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 110 for execution. Such a medium may take many forms, including, but not limited to, non-volatile media, volatile media, and transmission media. Non-volatile media may include storage devices, for example, optical or magnetic disks. Volatile media may include dynamic memory, such as the memory 120. Transmission media can also take the form of acoustic or light waves, such as those generated during Radio Frequency (RF) and InfraRed (IR) communications. Common forms of computer-readable media include, for example, floppy disk, a flexible disk, hard disk, magnetic tape, any other magnetic medium, a Compact Disc Read Only Memory (CD ROM), Digital Video Disc (DVD) any other optical medium, punch cards, paper tape, any other physical medium with patterns of holes, a Random Access Memory (RAM), a Programmable Read Only Memory (PROM), an Erasable Programmable Read Only Memory (EPROM), a Flash EPROM, any other memory chip or cartridge, a carrier wave as described hereinafter, or any other medium from which a computer can read.

Various forms of computer-readable media may be involved in carrying one or more sequences of instructions to the processor 110 for execution. For example, the instructions may initially be borne on a magnetic disk of a remote computer. The remote computer may load the instructions into its dynamic memory and send the instructions over a telephone line using a modem. A modem local to the computing system 101 may receive the data on the telephone line and use an infrared transmitter to convert the data to an infrared signal and place the data on the bus 150. The bus 150 may carry the data to the memory 120, from which the processor 110 retrieves and executes the instructions. The instructions received by the memory 120 may optionally be stored on a storage device either before or after execution by the processor 110.

In various embodiments, including embodiments in which the computing system 101 is a server, the communication interface portion of the system interface 140 may provide data communication through one or more networks to other data devices. For example, the communication interface may provide a connection through a local network to a host computer or to data equipment operated by an Internet Service Provider (ISP). The ISP may in turn provide data communication services through a packet data communication network, e.g., the “Internet.” These networks use electrical, electromagnetic, or optical signals that carry digital data streams. These signals are exemplary forms of carrier waves transporting the data.

The terminals 102 may send messages and receive data, including program codes, through the network(s) and the system interface 130. In at least one embodiment, the terminal 102 might transmit a requested code for an application program through the Internet, ISP, and/or the communication interface. In accordance with at least one embodiment, one such downloaded application provides for user interaction with the investment valuation system 100 using the interactive reports and display screens described herein. The received code may be executed by the processor 110 as it is received, and/or stored in a non-volatile storage device for later execution. In this manner, computing equipment 190 may obtain an application code in the form of a carrier wave.

The computing system 101 may receive commands and data from the terminals 102 and output program code and data to the terminals 102 using the network 104. In at least one embodiment, the computing system 101 server may generate and transmit the requested data to the requesting user via HTML formatted or XML formatted pages, which may be provided as World Wide Web pages, using the network 104. The network 104 may be, for example, a network of interconnected networks such as the Internet, a LAN, a WAN, an intranet including any of these, and/or a PSTN. The communications interface portion of the system interface 130 may further include a web browser or thin client. A thin client is a client portion of an application designed to require little memory so that the bulk of the data processing occurs on a corresponding server. In at least one embodiment, a thin client may be Java-based. The web browser may be configured to display data and communicate with other computers via a network such as, for example, the Internet or an intranet. The web browser may provide a user with a way to navigate, via, for example, hyperlinks which may be selected by the pointing device (such as a computer mouse), or as typed in by the user. The web browser uses a protocol such as, for example, HyperText Transfer Protocol (HTTP) or File Transfer Protocol (FTP), to transmit data of various content such as, for example, HTML formatted documents, plain text documents, graphic images, and XML documents for output presentation to the user via the display.

Web pages formatted in accordance with HTML or XML may also be provided in accordance with the Extensible Style Language (XSL) specification available from the World Wide Web Consortium. XSL is useful for separating style from content as well as for providing a common interface for sharing of web pages across applications. The web browser may also run or execute programs, such as Java applets including sequences of instructions provided in accordance with the Java programming language, or JavaScript. The web browser may be, for example, Internet Explorer® by Microsoft® Corporation, Netscape Navigator® by Netscape, or any other web browser. A thin client utilizes a two or more tiered client server model. In this model, the client runs a minimal set of services that provide functionality to interface with at least one server. A web browser may be a thin client. Web server 102 may run the Windows™ NT network operating system available from Microsoft™ Corporation or Redmond, Wash.

In at least one embodiment, instructions executed by the processor 110 from the memory 120 may include application software instructions that cause the processor 110 to perform the valuation modeling described herein. In at least this embodiment, these application instructions may be implemented in the form of source code statements provided in accordance with the Visual C++ and Visual Basic™ higher order programming languages, development kits for which are available from Microsoft® Corporation of Redmond, Wash. Other embodiments are possible. Application instructions may also include database scripts for accessing, storing, or selectively retrieving data contained in the database 105. The database scripts may be contained in a storage device or may be stored using the database 105. The database scripts may be implemented in the form of programming statements provided in accordance with, for example, SQL version 7.0 database management system query language. Database scripts may also be provided in accordance with Transact SQL using the ColdFusion™ database management system. Other database implementations are possible, including those available from Oracle™ or IBM DB2™.

In at least one embodiment, the user interface portion 140 application software instructions may include a GUI portion for generating interactive pages or display screens by which a user may provide data to and receive data from the computing system 101 using a human-machine interface such as, but not limited to, a display. Interactive pages may include user dialog boxes for accepting user entered data. The human-machine interface may also include a hardcopy generating device such as a printer. A user may interact with the computing system 101 via the graphical user interface provided by the GUI portion by using the pointing device and the data entry device. The GUI portion may place the output of the computing system 101 in a format for presentation to a user via the display.

In embodiments in which the computing device 101 is a server system, the computing system 101 may provide interactive pages by outputting the pages to a user at a terminal 102 using the network 104. The valuation reports 103 may be implemented using one or more such interactive pages. The interactive pages may be formatted in accordance with the HTM L or XML standards for display to the user by a web browser application of the terminal 102. Alternatively, the valuation reports 103 may be formatted as one or more printout files (e.g., “.prn” files) which are output by the computing device 101 to the terminal 102 using the network 104. Such printout files may be transmitted as an attachment to an electronic mail message, or transmitted in accordance with the FTP protocol.

In accordance with at least one embodiment of the invention, including the exemplary embodiments described above, the investment valuation system 100 may operate with, but is not limited to, three main categories of financial instruments, e.g., CDs (both coupon and zero coupon), namely non-callable CDs, callable CDs, and step-rate CDs. Based on general descriptive parameters and certain assumptions, the system and method intelligently defines the type of financial instrument and values it accordingly. The model and system may calculate the value of financial instruments using, for example, either straight yield to value formulas or using an option adjusted spread calculation.

In at least one embodiment, a tetranomial lattice model employing the Black-Karasinski interest rate process and a recursive valuation procedure may be used to value one or more financial instruments, such as, but not limited to, option-embedded CDs given various yield-curve shifts. An example of instructions implementing a recursive algorithm in an embodiment by calling a function of an add-in library module is given below:

=IF(AND(‘Pricing Model Assumptions’! $B$23<=‘Security Detail Pricing’! $BJ8,‘Security Detail Pricing’!$BJ8<=‘Pricing ModelAssumptions’!$C$23),‘Pricing Model Assumptions’!$E$23,IF(AND(‘Pricing Model Assumptions’!$B$24<‘Security Detail Pricing’!$BJ8,‘Security Detail Pricing’!$BJ8<=‘Pricing Model Assumptions’!$C$24),‘Pricing Model Assumptions’!$E$24,IF(AND(‘Pricing Model Assumptions’!$B$25<‘Security Detail Pricing’!$BJ8,‘Security Detail Pricing’! $BJ8<=‘Pricing Model Assumptions’!$C$25),‘Pricing Model Assumptions’!$E$25,IF(AND(‘Pricing Model Assumptions’!$B$26<‘Security Detail Pricing’!$BJ8,‘Security Detail Pricing’!$BJ8<=‘Pricing Model Assumptions’!$C$26),‘Pricing Model Assumptions’!$E$26,IF(AND(‘Pricing Model Assumptions’!$B$27<‘Security Detail Pricing’!$BJ8,‘Security Detail Pricing’!$BJ8<=‘Pricing Model Assumptions’!$C$27),‘Pricing Model Assumptions’!$E$27,””)))))

Further instructions implementing a recursive valuation algorithm by calling a function of an add-in library module are shown in the Computer Program Listing Appendix attached hereto, which is incorporated by reference as if fully set forth herein. In at least one embodiment, the recursive valuation algorithm may be implemented using Microsoft® Excel® spreadsheet cell formulas as shown above and in the appendix. The above cell formula also shows an example of an embodiment implementing a tetranomial lattice model by calling a function of an add-in library module. A tetranomial lattice model may be an intermediate approach between a binomial tree structure and a Monte Carlo simulation. As opposed to a binary tree, a tetranomial lattice model may begin its first step with four branches.

In at least one embodiment, the Black-Karasinski model may be used to perform the financial instrument valuation calculation, such as, for example, an option adjusted spread calculation according to Equation 1:

d(log r)=φ(t)[log μ(t)−log r]dt+σ(t)dz Eq.1

where: μ(t) is the target rate, φ(t) is the mean reversion, and σ(t) is the local volatility for the local change in log r.

Further details concerning the Black-Karasinski model may be found in, for example, F. Black and P. Karasinski, Bond and Option Prices When Short Rates Are Lognormal, Financial Analysts Journal, July-August, 1991, 52-59, which is hereby incorporated by reference as if set forth herein. The Black-Karasinski model may assume that the short-term interest rate has a lognormal distribution. An option adjusted spread calculation, which incorporates the Black-Karasinski interest rate process, may be the discrete term structure model used for valuation of financial instruments such as CDs. Other valuation models may be supported in addition to or instead of the Black-Karasinski model, such as, for example, the Black-Toy-Derman interest rate model.

In at least one embodiment, the recursive algorithm may be implemented using an add-in library module that includes a corresponding sequence of instructions such as, for example, the “@nalyst” add-in products available from Unisys/TechHackers, Inc. of New York, N.Y. Add-ins may be used in the way of a library function call, subroutine, or building block to provide an intermediate calculation, such as, for example, a calculation in a single worksheet cell, as part of a larger recursive calculation. Furthermore, the add-ins may be implemented using machine code instructions for particular computing platforms in order to provide fast run-time execution.

In accordance with at least one embodiment of the invention, the system and method may use different yield curves and make certain assumptions to value financial instruments such as CDs. The systems' and methods' market assumptions may be based on a current U.S. Treasury yield curve using standard benchmarks and a 1-year Constant Maturity Treasury (CMT) rate, brokered CD program weekly indicative rates, the London InterBank Offered Rate (LIBOR) rates for maturities one (1) year and shorter, as well as the U.S. swap rates for maturities two (2) years and greater.

All CD values may be modeled using, for example, certificate-specific data including an actual day count or a 365 day count and an assumed par of $1000 redemption price. All CD values may be modeled using a settlement date equal to that of the modeling date. General short rate volatility may be assumed to be 14% implied, while general long rate volatilities may be obtained from an interpolated Swaption Mid-Market Volatility Indication matrix. Callable CD spreads and fee assumptions are provided by the Bank of New York. Option adjusted spreads may be set at 57 basis points for callable CDs and step-rate CDs at their final steps, and at 97 basis points for multi-step CDs; these can be adjusted by CD traders. Call spreads may be set at +50 basis point spread to a brokered CD program's all-in yields, and can be adjusted by CD traders utilizing the CD value modeling system and method. Each of these items or portions thereof of this instrument-specific information (e.g., certificate-specific information) may be provided by the investment valuation system 100 in at least one embodiment.

Generically speaking, non-callable CDs may be valued to maturity. Callable CD values may be modeled to the call if the coupon is greater than the comparable treasury plus spread and fee premiums; otherwise, CD values may be modeled on an option adjusted spread basis. Step-rate CD, both single and multi-step CD, values may be modeled on an option adjusted spread basis. Zero coupon CD values may be modeled either to maturity or to the call date.

Turning now to the operation of the various embodiments of the invention, in at least one embodiment, the investment valuation system 100 may produce one or more valuation reports 103.

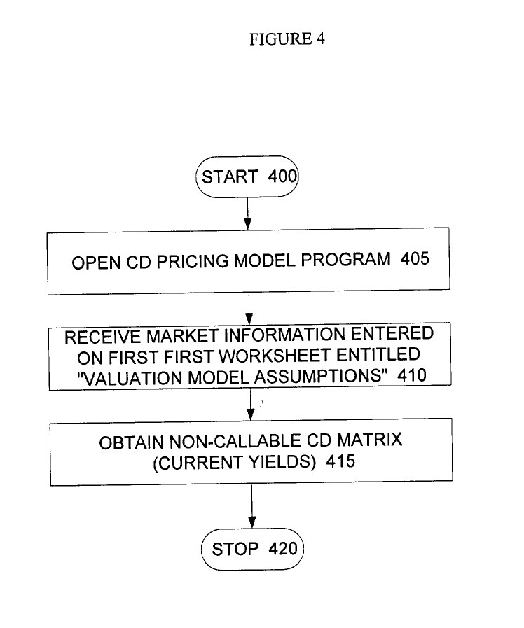

Various operations and processes performed by, or in interaction with, the investment valuation system and method designed in accordance with at least one embodiment of the invention are now provided in association with FIGS. 4-6 and 13.

As shown in FIG. 4, a method for performing maintenance data updates may begin at 400 and control proceeds to 405 at which investment valuation module 300 execution may commence. In at least one embodiment in which the valuation portion 301 is implemented using Microsoft® Excel™, a file may be opened to cause the Excel™ spreadsheet application to begin execution and to load and output to the user, spreadsheet data contained in that file. This file may be formatted as a “.xls” file compatible for execution with the Microsoft® Excel™ application. The resulting display of pricing model spreadsheet data may include one or more worksheets of spreadsheet data. An example of such a spreadsheet file is shown in the “ALVINCD formulas.pdf” file attached hereto as a Computer Program Listing Appendix.

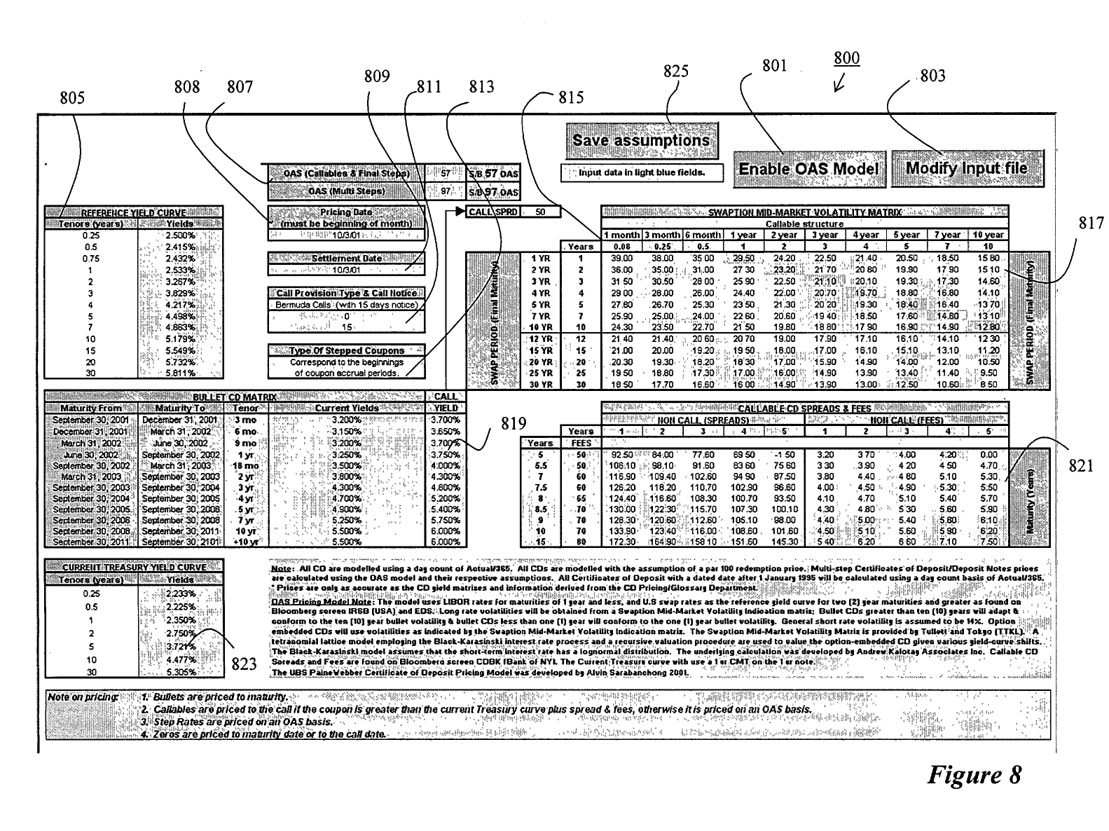

Control may then proceed to 410, at which market data may be entered on a first market data entry worksheet. For example, FIG. 8 illustrates a market data entry worksheet entitled “Valuation Model Assumptions.” In general, the investment valuation system 100 may support embodiments in which certain investment data is manually entered by a user as well as other embodiments in which investment data is obtained automatically from a database or a remote location. Data at a remote location may be obtained using a network such as the network 108. In accordance with at least one embodiment of the invention, it may be necessary to only update specific cells/fields. For embodiments in which data is manually entered, the investment valuation system 100 may highlight or color code cells/fields requiring update or entry; for example, the communication/GUI portion 303 may be configured to cause such cells/fields to be displayed using a light blue color.

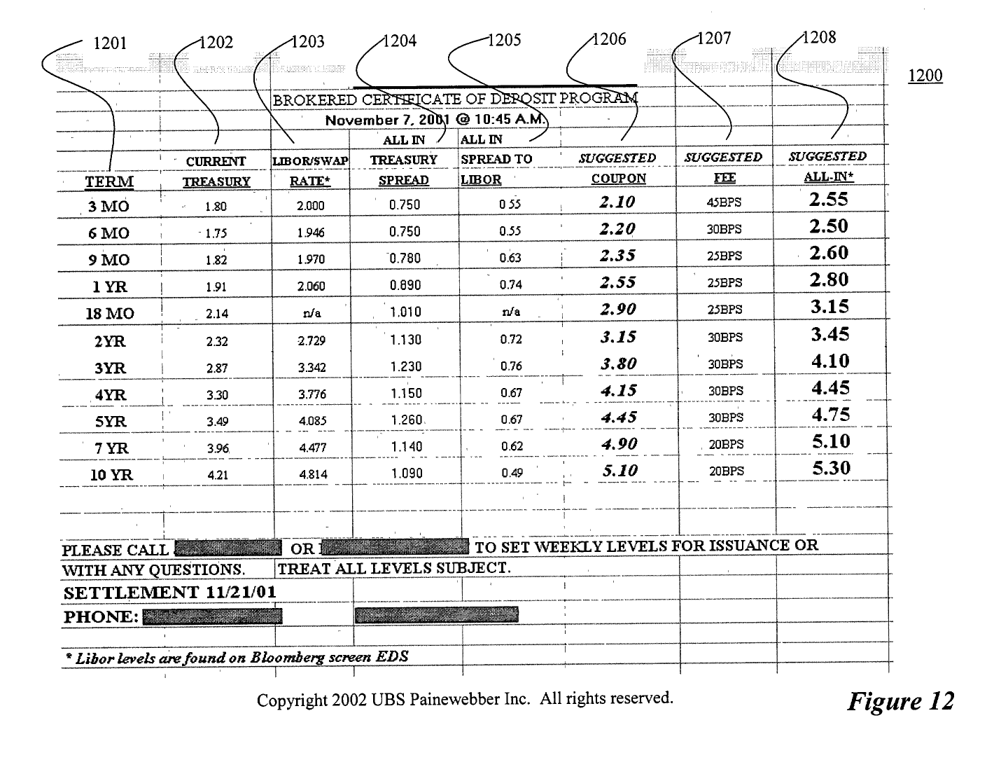

Control may then proceed to 415, at which non-callable CD matrix (current yields) may be obtained. The yields may be obtained from CD trader users interacting with the investment valuation method and system 100, from a database including these rates (such as the database 105), from another spreadsheet application executing at the computing system 101 containing the yield data, from a data feed coupled to the computing system 101 (via the network 108, for example), from one or more electronic messages received using a network, etc. In accordance with at least one embodiment of the invention, it may be necessary to only update specific cells/fields, for example, cells/fields that are colored light blue. Additionally, it may be useful to use rate information that represents the resultant rates available for a financial instrument after accounting for various factors including spreads and fees. Instrument-specific information associated with a given financial instrument may include such resultant rate information. For example, FIG. 12 shows an example “all-in rate” page 1200 that may include a suggested all-in rate 1208 (e.g., “SUGGESTED ALL-IN*” rates listed in the rightmost column of FIG. 12) for multiple financial instruments having different terms 1201 and accounting for such factors as the current treasury rate 1202, the LIBOR/swap rate 1203, the all-in treasury spread 1204, the all-in spread to LIBOR 1205, the suggested coupon 1206, and a suggested brokerage fee 1207. Suggested brokerage fee 1207 may be expressed in terms of basis points. Control may then proceed to 420 at which the processes end. The processes performed in FIG. 4 may be advantageously performed periodically, for example, each week, e.g., on Mondays or the first day of the workweek.

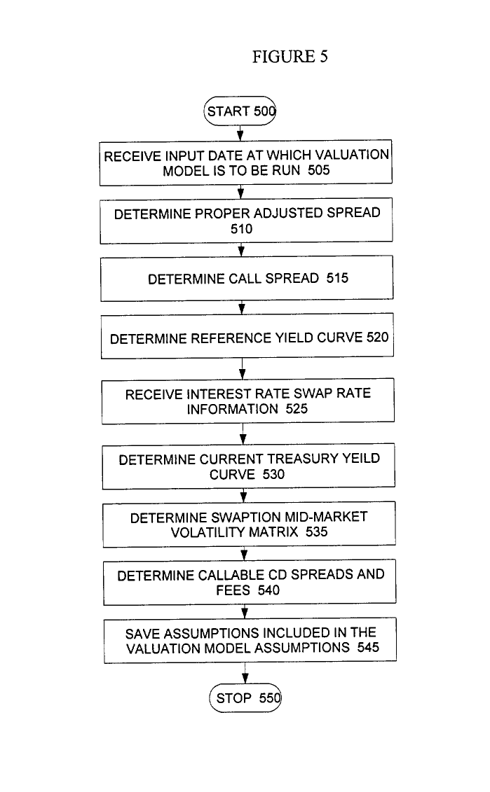

FIG. 5 illustrates a process for entering market data using an exemplary worksheet entitled “Valuation Model Assumptions” (an example of which being illustrated in FIG. 8). In accordance with at least one embodiment, it may be necessary to only update specific cells/fields of the worksheet, for example, cells/fields that are colored light blue. The process begins at 500 and control proceeds to 505, at which the input date for which the valuation model is to be run may be determined. In at least one embodiment, the input date may be input by a user using a data entry device of the computing system 101. Alternatively, the input date may be obtained from a system clock by, for example, one or more instructions executing a system call to the operating system to obtain the current system date and time.

Subsequently, control may proceed to 510, at which the proper adjusted spread is determined, for example, by querying a CD trader operator, a predefined value stored in the database 105, or data feed for the proper option adjusted spread to use (these may remain constant at 57 and 97 basis points, respectively, unless there is extreme volatility in the market). Control may then proceed to 515, at which the call spread is determined by, for example, querying a CD trader, a predefined value stored in the database 105, or data feed for the call spread (this spread may remain at 50 unless otherwise indicated by the trader, database or data feed). In at least one embodiment, the call spread may be obtained using a screen scraper application to extract the call spread data from a data transmission intended for display or transmission from a mainframe system. A screen scraper is a software application that allows a computer to intercept character-based data destined for output using a printer or monochrome CRT display coupled to, for example, a mainframe computer. The screen scraper may present the captured information in an easier to understand GUI formatted using, for example, HTML, for access and output using a browser. An example of a screen scraper includes the Mosaic™ product available from SEEC, Inc. of Pittsburgh, Pa. Data feeds may be live feed investment messages provided by an external reporting service, such as Reuters™. Control may then proceed to 520, at which the reference yield curve is determined. This determination may require a user to enter yield curve reference data obtained from viewing various different screens of a user interface associated with an external market data provider such as, for example, Bloomberg™. To access financial market data available from Bloomberg™, the user may enter “Bloomberg.com” as a World Wide Web (WWW) Uniform Resource Locator (URL) using a web browser, such as the web browser of the computing system 101. Upon receiving the Bloomberg™ home web page, a user may use the pointing device to traverse the Bloomberg™ web site as required to find the desired yield curve data displayed on an interactive web page. Sources other than Bloomberg™ may be used. Alternatively, the reference yield curve may be determined by the investment valuation module 500 based on access to databases, including predefined yield data stored using the database 105, or data feed data associated with market data providers, or from a screen scraper application.

In particular at 520, a user may be instructed to access instrument market-specific data such as that associated with International Monetary Market EuroDollar Futures Analysis for yields from 0.25 years (3 months) through 10 years. This may be done, for example, by accessing Bloomberg™, entering “EDS” into a “search” field and selecting the green <GO> key. This may result in display of a “IMM EURODOLLAR FUTURES ANALYSIS” page via the GUI of the user interface as provided by the external financial data provider. Alternatively, this action may be performed automatically or semi-automatically by the data retrieval portion 302 accessing a database of current financial data, such as the database 105, a screen scraper, or a data feed to obtain instrument market-specific data. A user may also be instructed to ensure that the date on the upper left-hand corner of the screen is the same as the modeling date used by the investment valuation system 100. The user may also be instructed to input instrument market-specific data such as LIBOR 3, 6, 9 month and 1 year rates, e.g., inputting them at the top of a GUI screen, as well as the SWAP 2, 4, 5, 7 and 10-year rates, e.g., on a second line; alternatively, this data may be input without human action, either automatically or semi-automatically in response to completion of a previous operation.

The communication/GUI portion 303 may prompt the user to enter instrument market-specific data by providing an interactive dialog box or message box instructing the user to enter particular data, or to select from among a multitude of options provided using a pull-down menu.

Referring again to FIG. 5, control may then proceed to 525, where a user may be instructed to enter interest rate swap rate data for 15, 20, and 30-year yields. This may be performed by the user accessing data from a financial data provider, (e.g., accessing Bloomberg™, entering “IRSB” into a search box, selecting the green <GO> key to view an “INTEREST RATE SWAP RATES” page, entering “18” for the United States and selecting the green <GO> key), accessing a database of financial data such as the database 105, extracting the data using a screen scraper, or accessing a data feed of that instrument market-specific data. The user or system may then input ‘ask side’ rates for the 15, 20, and 30 year rates.

Control then may proceed to 530, at which the current treasury yield curve is determined. For rates on the current treasury curve, the user may be instructed to provide this instrument market-specific data. This may be done by, for example, the user accessing Bloomberg™ and entering “C15” followed by selecting the green <GO> key, pressing the ‘Tab’ key four times until the user is at the date field. The user may then be instructed to enter the same date as the valuation date being used, if it is not already correct, select <GO> and then select the green <PAGE FWD> key once. This may cause display of current CD yields in a third column. A user may then be instructed to copy the current CD yields over to the investment valuation system 100 user interface, using the pointing device. A one year rate may or may not be available as a result of these steps. Therefore, a user may be instructed to access Bloomberg™, enter “PX3,” select <GO>, and find the month and year that represents the note maturing one year from the valuation date. The user may also be instructed to page forward through the Bloomberg™ data to locate the one year rate and to take an average of the rates for the one year note, and to enter this rate into the model. Alternatively, the system 100 may access the instrument market-specific data automatically or semi-automatically by accessing a database, accessing a data feed, or extracting it using a screen scraper.

Control then may proceed to 535 at which the swaption mid-market volatility matrix is determined. The term “swaption” is well known in the financial art as an option on a interest rate swap. In particular, the buyer of a swaption has the right to enter into an interest rate swap agreement by some specified date in the future. The swaption agreement may specify whether the buyer of the swaption will be a fixed-rate receiver or a fixed-rate payer. The writer of the swaption may become the counterparty if the buyer exercises. These the swaption mid-market volatility indications may be obtained from financial market data providers. For example, using Bloomberg™, a user may be instructed to enter “TTKL,” select <GO> (Note: Bloomberg™ may require subscription access to this page). The user may then be instructed to select option “3” for U.S. Dollar; then select option “6” for Swaption Volatility. This instrument market-specific data may be contained on multiple pages, for example, four (4) pages of data. If there is any other missing data on these pages, the user may need to interpolate the proper volatility to use. Alternatively, the system 100 may access the instrument market-specific data automatically or semi-automatically by accessing a database, accessing a data feed, or extracting it using a screen scraper.

Control may then proceed to 540, at which callable CD spreads and fees are determined. This may be performed if a user can obtain this instrument-specific data from a financial market data provider, e.g., Bloomberg™; however, the user may need to have subscription rights to the requisite pages within the financial market data provider's web-site. Using financial market data provider Bloomberg™ for an example, the user may be instructed to enter “BKNY” and select <GO>. This will result in the “The Bank of New York U.S. AGENCY SPREADS” page being displayed. Once the user has selected option number “1.” (Assumptions for Callable Issue”) and selects <GO>, the user can access the spreads and fees pages respectively for the instrument-specific data needed. The user may have to change the years and fees (basis points) on the top and left column of the model's matrix. If the data is unavailable, a user may use the data already provided on the model. Alternatively, the system may be able to access the market-specific data automatically or semi-automatically by accessing a database, accessing a data feed, or extracting it using a screen scraper.

After the requisite instrument-specific data and instrument market-specific data is input into fields on the Value Model Assumptions worksheet (an example of with being illustrated in FIG. 8), control may proceed to 545. At 545, the user may be instructed to save the assumptions included in the valuation model assumptions worksheet in a CD valuation model file, e.g., an “.xls” file such as “CD Pricing Model.xls.” (An example of a financial instrument valuation model is included herein as an Computer Program Listing Appendix including the file shown as “ALVINCD formulas.pdf.”) Subsequently, the user may be instructed to enter the date (valuation/current date) in numeric characters and without the “/” symbol (e.g. Sep. 26, 2001 should be input as “092601”). This may cause the user's market data inputs to be saved in an archive reference (for example, the database 105, or stored in the memory 120 described above or in some other memory). Control then may proceed to 550, at which the processes may end. The processes illustrated in FIG. 5 may be advantageously performed daily at or near the close of business or relevant market close, e.g., approximately 4:30 pm.

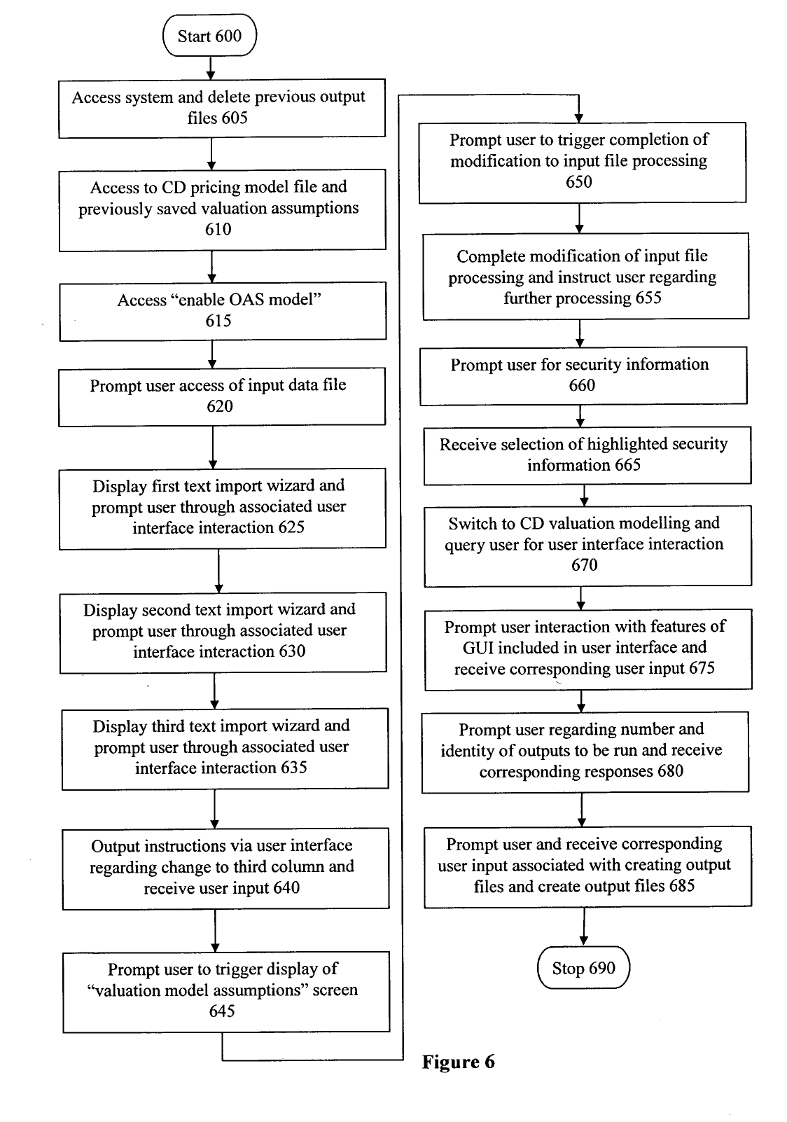

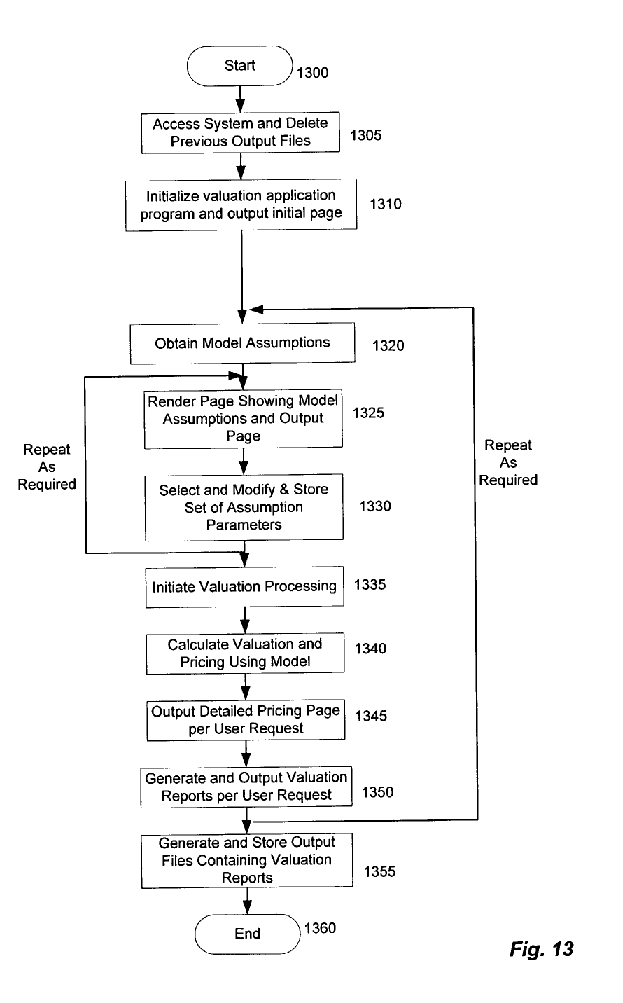

FIG. 6 illustrates one method for determining the current value of fixed income investments such as, but not limited to, CDs in accordance with at least one embodiment of the invention. The processes performed in FIG. 6 may be advantageously performed daily at or near the close of business or relevant market close, e.g., approximately 5:15 pm daily. Various embodiments of the method may include one or more non-automated or semi-automated portions. FIG. 6 illustrates at least one embodiment of the method having more than one non-automated portion. Alternatively, FIG. 13 is a flow chart illustrating at least one embodiment of the method having additional automated portions. Other embodiments are possible, such as embodiments in which certain portions of the method are automated while others are non-automated or semi-automated (i.e., the user interacts with an interactive display or assistant) ranging between the embodiments of FIGS. 6 and 13.

At least one embodiment emphasizing non-automated processes is illustrated in FIG. 6. Referring to FIG. 6, the processes begin at 600 and control proceeds to 605. At 605, the computing system 101 on which all or part of the investment valuation system 100 is installed may be accessed. In exemplary embodiments in which users access the investment valuation system 100 using a network, the computing system 101 may download to the requesting terminal 102 a client portion of the user interface 140 for receiving and outputting interactive pages as described herein.

In at least one embodiment, investment valuation module 300 may delete prior output files for initialization. In at least one embodiment, two files in particular, e.g., “cdpricing-output.xls” and “cdpricing-output.prn” files, may be deleted. Control then may proceed to 610, at which valuation portion 301, data retrieval portion 302, and communications/GUI portion 303 may be executed. In at least one embodiment that includes programmed instructions provided in accordance with the Excel™ spreadsheet application, the “CD Pricing Model.xls” file may be accessed and the previously saved valuation model assumptions are accessed by, for example, clicking on the first tab on the bottom labeled “Valuation Model Assumptions” (not shown).

Control may then proceed to 615, at which the user may enable the modeling functions described herein. In at least one embodiment, the user may enable modeling by selecting the “Enable OAS Model” icon 801, an example of which being illustrated in FIG. 8. Control may then proceed to 620, at which a user may be prompted to select an input parameters file by, for example, selecting the “Modify Input File” icon 803 (see FIG. 8). In at least one embodiment, user selection of the input parameters file may cause the data retrieval portion 302 to obtain from storage the “cdpricing-input.txt” file. FIG. 7 illustrates an example of an input parameters file in accordance with at least one embodiment.

Referring to FIG. 7, an input parameter file 700 may include, as a minimum, instrument-specific data such as, but not limited to security type (e.g., 1=bullet, 2=callable, 3=steprate) 701, a security identifier 702, a Committee on Uniform Security Identification Procedures (CUSIP) number 703, a description 705, a coupon 707, a maturity date 709, a dated date 711, a first coupon date 713, and a coupon frequency 715. The security type 701 may classify the subject financial instrument according to a variety of attributes such as, but not limited to, bullet, callable, or steprate characteristics. (A bullet instrument may not be callable by the issuer, while a callable instrument may be redeemed by the issuer prior to its maturity date. A steprate instrument may have a periodically changing interest rate.) The security identifier 702 may be a transaction code assigned by the investment valuation system 100 for tracking and/or authentication purposes. The CUSIP number 703 may be a number assigned to the corresponding security by the American Bankers Association for the purpose of identifying the security in transactions involving it. The CUSIP number 703 may include nine characters specifying the issuer, the issue, and a check digit. Further information concerning the CUSIP number 703 may be obtained from Standard & Poor's CUSIP Service Bureau located in New York, N.Y. The description 705 may be a text field describing the issuer and type of security. The coupon 707 may specify the financial instrument-interest bearing rate. The maturity date 709 may specify the date on which the issuer must pay the face value of the instrument. The dated date 711 may be the issuance date for the security. The first coupon date 713 may be the date the first interest payment is due for the instrument. The coupon frequency 715 may indicate the frequency of interest payments for the instrument. It may be necessary for the user to ensure that the “cdpricing-input.txt” file time and date stamp is the current time and date.

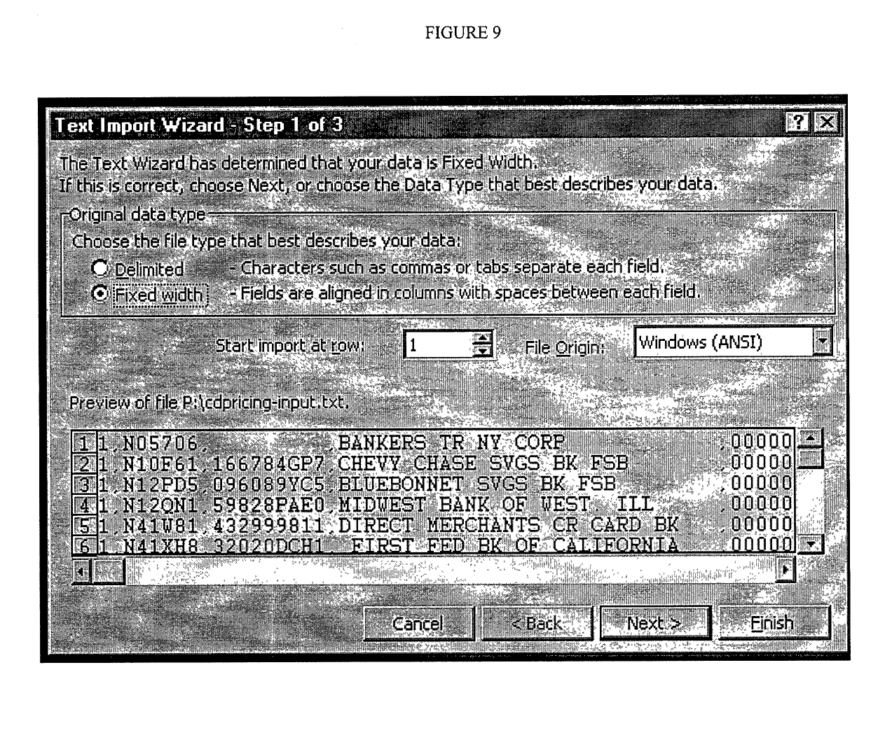

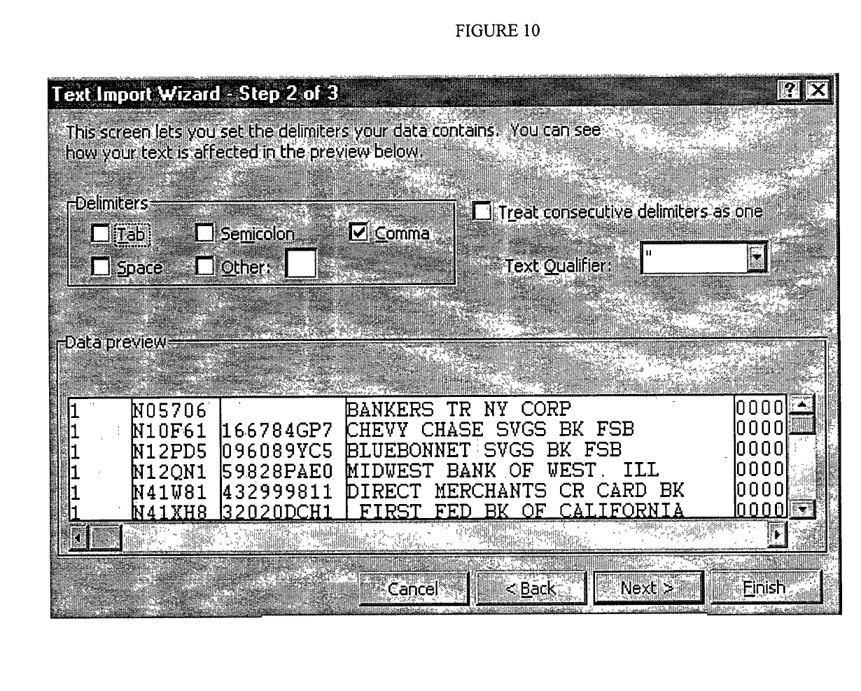

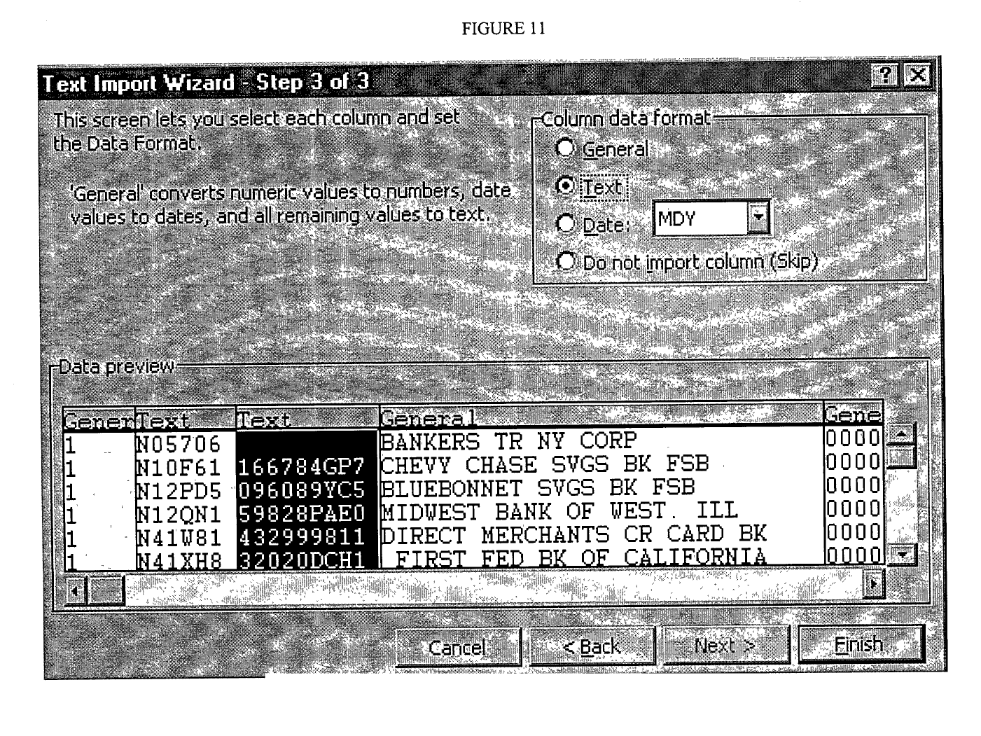

Referring again to FIG. 6, control then may proceed to 625, at which time a first Text Import Wizard (1 of 3) pop-up window may be output to the user (an example of which being illustrated in FIG. 9). A user may then be instructed to choose “Delimited” as the Original data type and to select “Next >”. Control may then proceed to 630, at which time a second Text Import Wizard (2 of 3) pop-up window may be output to the user (an example of which being illustrated in FIG. 10). A user may then be instructed to choose “Comma” as the Delimiter and to select “Next >.” Control may then proceed to 635, at which a third Text Import Wizard (3 of 3) pop-up window may be output to the user (an example of which being illustrated in FIG. 11). A user may then be instructed to select the second column and then choose “Text” in the upper right box labeled “Column data format”. The heading on the second column may in response change from “General” to “Text”. Control may then proceed to 640, at which a user may be instructed to select the third column and then choose “Text” in the upper right box labeled “Column data format”. The heading on the column may in response change from “General” to “Text”. Control may then proceed to 645, at which a user may be instructed to select the “Finish” icon on the lower right corner of the window. Upon user selection of the “Finish” icon, the communication/GUI portion 303 may output to the user a “Valuation Model Assumptions” display (an example of which being illustrated in FIG. 8). In response to a user's instructions, the communication/GUI portion 303 may request the data retrieval portion 302 to execute one or more sequences of instructions operable to obtain the assumptions data (see FIG. 8) from the database 105. Alternatively, or in addition, the data retrieval portion 302 may obtain portions of the assumptions data from external sources using an electronic link such as, but not limited to, the network 104. Upon receiving the assumptions data from the data retrieval portion 302, communication/GUI portion 303 may generate and/or output a Valuation Model Assumptions interactive page 800 (see FIG. 8).

As shown in FIG. 8, a valuation model assumptions page 800 may include an enable modeling functions icon 801, a modify input parameters icon 803, a reference yield curve 805, Option Adjusted Spread (OAS) data 807, a pricing date 809, an indication of call provision type and call notice 811, an indication of the type of stepped coupons 813, a call spread 815, a swaption mid-market volatility matrix 817, a bullet CD matrix 819, a callable CD spreads and fees matrix 821, and a current treasury yield curve 823. In at least one embodiment, the actual pricing and valuation calculations of individual securities or financial instruments may take into account all or a portion of the various assumptions shown in the example assumptions input sheet of FIG. 8. Each pricing or valuation calculation for the individual bullet, callable, and step rate securities or financial instruments may take into account market levels as indicated for the treasury curve 823, swap curves such as those defined by swaption mid-market volatility matrix 817, trader initiated all-in rates (see FIG. 12), and volatility assumptions, as a minimum, as required to determine accurate spot pricing of the securities or financial instruments.

Referring again to FIG. 6, control may then proceed to 650, at which a user may be requested to modify the input assumptions to the model. The user may be so requested through the use of a message box. In at least one embodiment, the user may select the “Modify Input File” icon 803 (see FIG. 8) to request modification of the input assumptions. In at least one embodiment, the user may wait for a period of time for the investment valuation module 300 to process this request. For example, in one embodiment this may take about three minutes to complete. In at least one embodiment, the delay is incurred by the investment valuation module 300 obtaining the currently stored input data from the database 105 and in generating or rendering an interactive page in which the retrieved input data is formatted for output to the user.

Control may then proceed to 655 after the rendering process is finished, at which a user is instructed to select a first set of assumption parameters for modification. Upon user selection of the first set of input parameters for modification, the investment valuation module 300 may generate an interactive page containing the associated current input parametric data obtained from the database 105 and output the interactive page to the user. In at least one embodiment, interactive pages generated by embodiments of the investment valuation system 100 according to FIG. 6, including the input parameter modification page at 655, may be provided in the form of one or more worksheets of a spreadsheet application, as shown in FIG. 7, for example. As such, the worksheets may include multiple cells arranged according to a row and column format, each being individually formattable and selectable by a user using a pointing device. The data contained in each cell may be modified by the user using a data entry device. In addition, multiple cells may be selected for common formatting or operation in a single user action.

Control may then proceed to 660, at which a user may be prompted (using a message box, for example) to select the range of data containing security data. In at least one embodiment, columns A through BV of the first parameter worksheet may be selected. The number of rows to select depends on the number of securities contained in the corresponding output section. In at least one embodiment, all the output pages, except the last output, may have 2000 (Highlight range A1:BV2000) cells selected, corresponding to 2000 securities. That is, the investment valuation system 100 may price financial instruments in blocks of 2000, or some other convenient block size. In at least one embodiment, the user may need to copy (onto a cut and paste clipboard), using the pointing device, the security descriptive data from the CDPRICING-INPUT.txt file into the investment valuation system 100 to price. The investment valuation system 100 may then price the block at one time. The investment valuation system 100 also may segregate the input data into consistent 2000 security blocks, which may reside within the range A1:BV2000. Thus, this consistent block may need to be copied over multiple times to price a full number of securities.

Control may then proceed to 665, at which the range of securities chosen for pricing may be selected by a user using a pointing device.

Control then may proceed to 670, at which the investment valuation module 300 may cause the valuation portion 301 to be called to perform valuation pricing. At this point, the user may be prompted to select a second tab on the spreadsheet. The second tab may be labeled “Security Detail Pricing.” Upon user selection of the “Security Detail Pricing” tab, the communication/GUI portion 303 may generate an interactive page containing the pricing outputs generated by the valuation portion 301 and output the interactive page to the user. Upon user request to view detailed data associated with a particular security, the communications/GUI portion 303 may generate an interactive page showing detailed pricing and assumptions data associated with the selected security. In at least one embodiment, the user may request to view security details by selecting the “Go to Security” icon. Selecting the “Go to Security” icons may trigger display security details, while selecting the “Pricing Section” icons may trigger display of a final price value.

Control then proceeds to 675 at which the user may be instructed to interact with specific features of the interactive page displayed in the GUI of the computing system 101 user interface. For example, a user may be instructed to choose a cell on a worksheet, such as cell “BE8,” select “Edit”, Paste Special . . . ”, select “Values” at the top “Paste” section toolbar, and select “OK”. These operations may cause the security data copied at 660 to be pasted into one or more cells of the pricing output interactive page. The user may then be instructed to wait for data to paste into the memory locations associated with the pricing model. The user may also be instructed to select the “Go to Price” icon at the top toolbar and to select the “F9” icon on the user's keyboard to request the valuation portion 301 to calculate the pricing values. Upon the user selecting the “F9” icon requesting valuation, the valuation portion 301 may execute a sequence of programmed instructions performing the price modeling calculations as described herein.

In at least one embodiment, the investment valuation system 100 may not recalculate price values automatically. In such an embodiment, it may be necessary for the user to recalculate values for each of multiple output sections using the process described above. The user may then be instructed to wait for the pricing calculation process to finish. In one embodiment, the interactive page may show the status (e.g., calculating cells: 66%).

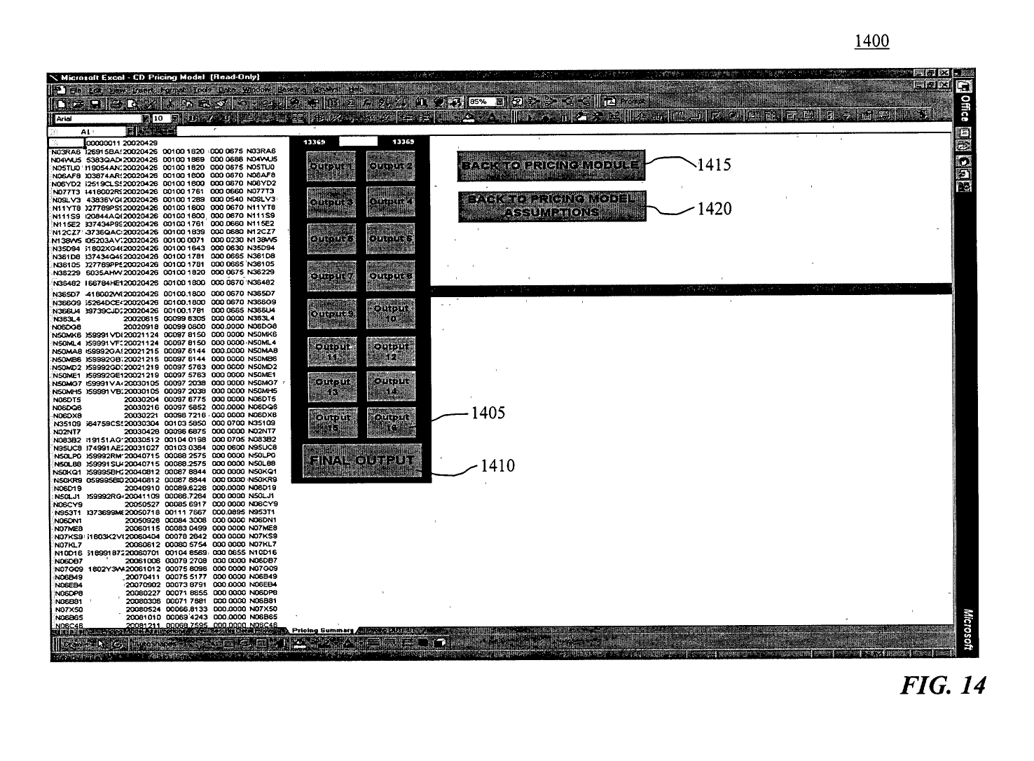

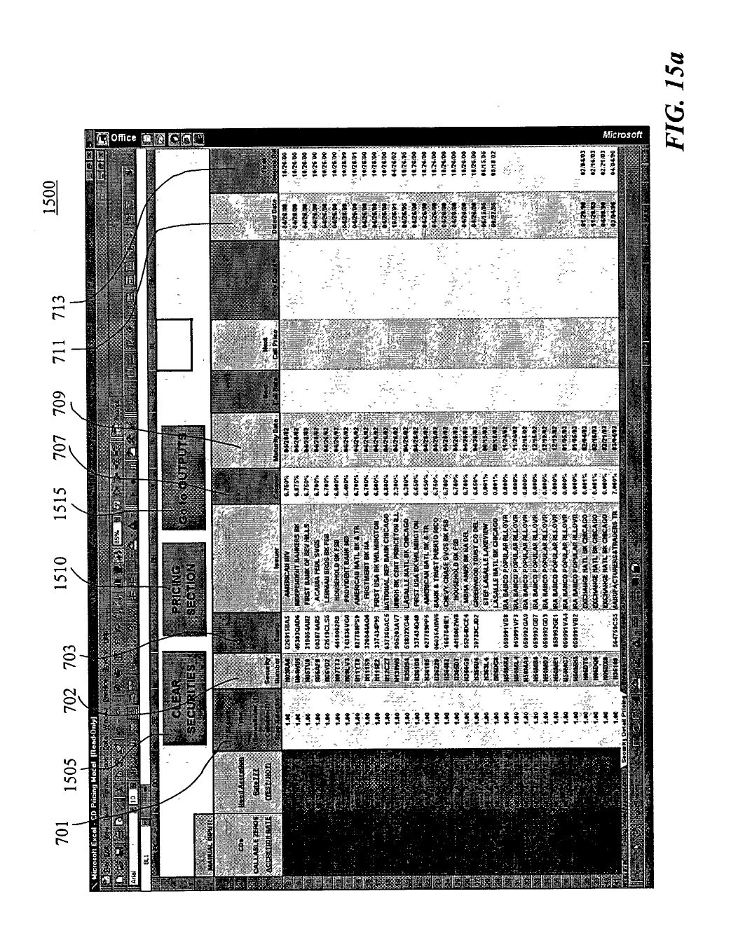

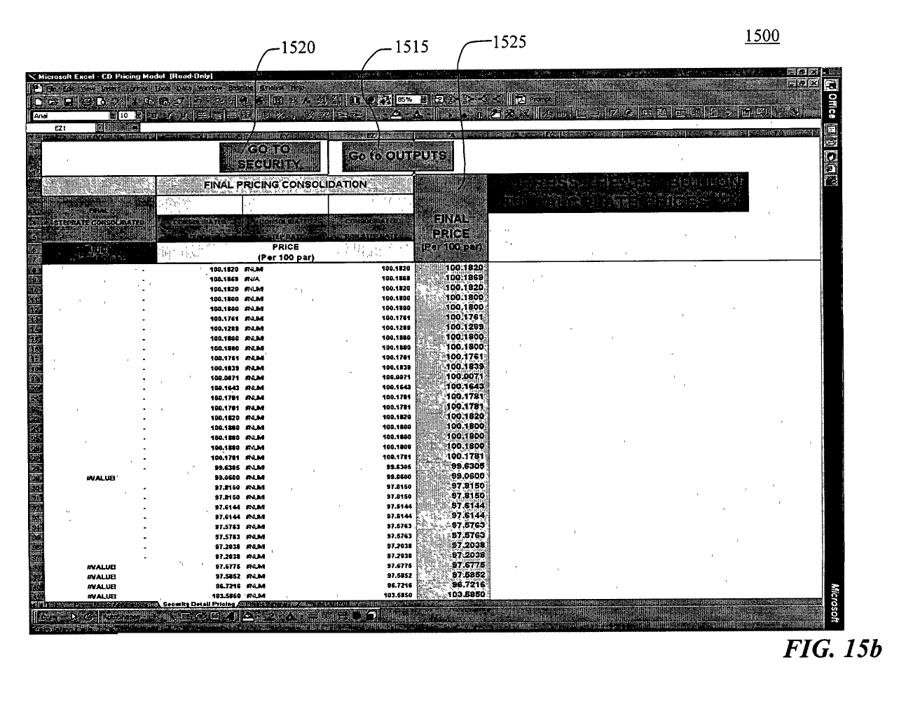

Control may then proceed to 680, at which the user may also be instructed to select a third tab on the worksheet to view a pricing summary report 103. In at least one embodiment, this summary report 103 may be requested by the user selecting a tab labeled “Pricing Summary”. The investment valuation system 100 may determine how many separate output reports 103 can be generated. An example of a pricing summary report 1400 according to at least one embodiment is shown in FIG. 14. Referring to FIG. 14, the pricing summary report 1400 may include individual output selection buttons 1405, a final output request button 1410, a “Back to Pricing Module” button 1415, and a “Back to Pricing Model Assumptions” button 1420. In at least one embodiment, the communication/GUI portion 303 may display in the top right of the pricing summary report 1400 worksheet (colored dark blue) an indication of how many outputs must run. In at least one embodiment, there may be several possible outputs; however, a user only needs to request the number of outputs indicated on the worksheet interactive page. For example, memory and/or processing bandwidth constraints of the equipment 190 in at least one embodiment may make it desirable to perform the financial instrument valuation output described herein in portions (e.g., 2,000 securities at a time) until a final output valuation is accomplished. Alternatively, the entire valuation may be output in a single pass. In the example pricing summary report 1400 of FIG. 14, the user may run up to sixteen (16) different outputs 1405. The user may be instructed to request generation of the first output report 103 by selecting the “Output 1” icon or button 1405. The user may need to run output 1, 2, 3, etc. depending on the number of outputs indicated. After each output report 103 is complete, a message indicating “Output # Complete” on the pricing summary report 1400 on the banner may be displayed. A “Security Detail Pricing” page 1500 may then be displayed as shown, for example, in FIGS. 15a and 15b. If the banner on the pricing summary report 1400 indicates to a user “You need to only run Output 1 through 4.”, the user should run Outputs 1 through Output 4 inclusive. The communication/GUI portion 301 may display a red banner on the middle of the interactive page to indicate “Output 4 Complete” when the user has completed the necessary tasks.

Following performing the required number of outputs, the user may be instructed to select the “Go to Security” icon or button 1520 and to subsequently select the “Clear Securities” icon or button 1505. The user may then be instructed to access the “cd pricinginput.txt” file and select the next section of securities. A user may be instructed to repeat various processes at 655 through 680 until the user has completed the number of output reports 103 necessary. The user may also be prompted to ensure that when copying the range from the last output page, the user copies only the range where there are securities, and not all 2000 rows.

Once the user has completed all data input, control proceeds to 485 at which the user may be instructed to request generation of files containing the price output reports 103. In particular, the user may be instructed to select a “Create output files” icon provided in at least one embodiment. Selection of this icon may cause the investment valuation module 300 to complete the valuation process and to produce the associated output files. In at least one embodiment, the output files thus generated are the “cdpricing-output.xls” and “cdpricing-output.prn” files. The output files may be stored using the database 105. The process of generating the output files may, in some embodiments, take approximately five minutes to complete. Following generation of the output files, all files may then be closed without saving changes to the files. Control may then proceed to 690, at which the processes end.

FIG. 13 illustrates one method for determining the current value of fixed income investments such as, but not limited to, CDs in accordance with at least one other embodiment of the invention. The processes performed in FIG. 13 may be advantageously performed daily at or near the close of business or relevant market close, e.g., approximately 5:15 pm daily. FIG. 13 is a flow chart illustrating at least one embodiment of the method emphasizing automated processes. Other embodiments are possible, such as embodiments in which certain portions of the method are automated while others are non-automated or semi-automated (i.e., the user interacts with an interactive display or assistant) with the degree of user interaction ranging between the embodiments of FIGS. 6 and 13.

Referring to FIG. 13, the processes begin at 1300 and control proceeds to 1305. At 1305, the computing system 101 on which all or part of the investment valuation system 100 is installed may be accessed. In embodiments in which the computing system 101 hosting the investment valuation module 300 is a server system, the access request may be received from a terminal 102 via the network 104. In these embodiments, a user at a terminal 102 may request access to the investment valuation system 100 by, for example, using a data entry device to enter the URL associated with the computing system 101 server into the web browser address line of the web browser running at the terminal 102. In response, the web browser of terminal 102 may transmit an electronic message, using the network 104, to the computing system 101 server requesting access to the investment valuation system 100. This request message may be formatted in accordance with the HTTP standard.

In other embodiments, the user at computing system 101 may request access to the investment valuation module 300 by selecting, using either a pointing device or a data entry device of the computing system 101, the investment valuation module 300 executable file to be run.

Upon receiving the request to access the investment valuation system 100, control then may proceed to 1310, at which valuation portion 301, data retrieval portion 302, and communications/GUI portion 303 may be executed to commence performance of the modeling functions described herein. In particular, the investment valuation module 300 may perform startup initialization and system access at 1310. In at least one embodiment, investment valuation module 300 may delete prior output files for initialization. Alternatively, the data retrieval portion 302 may overwrite the data in the output files during generation of the new output files. Following startup initialization of the investment valuation module 300, the communication/GUI portion 303 may generate an initial interactive page containing user selectable commands and user instructions. In embodiments in which the computing system 101 hosting the investment valuation module 300 is a server system, the initial interactive page may be transmitted to the requesting terminal 102 via the network 104. In at least one embodiment, the initial interactive page may be formatted in accordance with the HyperText Markup Language (HTML) standard.

Returning to FIG. 13, following initialization, control may then proceed to 1320. At 1320, the communication/GUI portion 303 may output to the user a “Valuation Model Assumptions” display (an example of which being illustrated in FIG. 8). The communication/GUI portion 303 may request the data retrieval portion 302 to execute one or more sequences of instructions operable to obtain the current assumptions data, as illustrated in FIG. 8, from the database 105. Alternatively, or in addition, the data retrieval portion 302 may obtain portions of the assumptions data from external sources using an electronic link such as, but not limited to, the network 104. Upon receiving the current assumptions data from the data retrieval portion 302, communication/GUI portion 303 may generate a Valuation Model Assumptions interactive page 800, an example of which is shown in FIG. 8, previously described. In embodiments in which the computing system 101 hosting the investment valuation module 300 is a server system, the Valuation Model Assumptions page may be transmitted to the requesting terminal 102 via the network 104.

Control may then proceed to 1325, at which a user may be prompted to modify input parameters by, for example, selecting a “Modify Input File” icon or button 803 provided for that purpose in an interactive page such as that shown, for example, in FIG. 8. In at least one embodiment, upon the communication/GUI portion 303 (illustrated in FIG. 3) receiving a user request to modify input parameters, the data retrieval portion 302 may obtain from the database 105 the requested parameters. The communication/GUI portion 303 may format the obtained input parameter data into an interactive page and output the page to the user. In at least one embodiment, the input parameters may be stored using the “cdpricing-input.txt” file. FIG. 7, as previously described, illustrates an example of an input parameters interactive page provided in response to user selection of the “Modify Input File” 803 of FIG. 8, in accordance with at least one embodiment. In embodiments in which the computing system 101 (see FIG. 1) hosting the investment valuation module 300 is a server system (see FIG. 3), the input parameters interactive page may be transmitted to the requesting terminal 102 via the network 104.

Following user modification of the input parameters, the user may cause the investment valuation module 300 to save the new or modified input parameters by selecting an icon or other interactive link provided for that purpose, such as the “Save assumptions” button 825 of FIG. 8. In at least one embodiment, user selection of the “save assumptions” command may cause the updated input data to be transmitted by the terminal 102 to the computing system 101 server in the form of an interactive page containing the modified data. At the computing system 101, the data retrieval portion 302 may execute one or more instruction scripts operable to store the updated input data using the database 105. Upon user request to modify model assumptions, the user may wait for a period of time for the investment valuation module 300 to process the request. For example, this may take about three minutes to complete. In at least one embodiment, the delay is incurred by the investment valuation module 300 obtaining the currently stored input data from the database 105 and in generating or rendering an interactive page in which the retrieved input data is formatted for output to the user.

Control may then proceed to 1330, after the rendering process is finished. At 1330, a user may be instructed to select a first set of assumption parameters for modification. Upon user selection of the first set of input parameters for modification, the investment valuation module 300 (see FIG. 3) may generate an interactive page containing the associated current input parametric data obtained from the database 105 (see FIG. 1) associated with the financial instrument and output the interactive page to the user. In embodiments in which the computing system 101 hosting the investment valuation module 300 is a server system, the input parameters interactive page may be transmitted to the requesting terminal 102 via the network 104. In at least one embodiment, interactive pages generated by embodiments of the investment valuation system 100 according to FIG. 13, including the input parameter modification page at 1330, may be provided in the form of one or more interactive pages of a web browser application. As such, the interactive pages may include multiple hyperlinks, each being selectable by a user using a pointing device. These hyperlinks may be arranged according to a row and column format. The data or data associated with each link may be modified by the user using a data entry device. An example of financial instrument specific information is shown in FIGS. 15a and 15b.

The user may modify the selected input parameters contained in the input parameters interactive page using a data entry device. Following user modification of the input parameters, the user may cause the investment valuation module 300 to save the new or modified input parameters by selecting an icon or other interactive link provided for that purpose. These input parameters may include instrument-specific data and instrument market-specific data as described herein.

Control may then proceed to 1335, at which the investment valuation module 300 may cause the valuation portion 301 to be called to perform financial instrument valuation pricing. It should be understood that the valuation portion 301 may perform valuation pricing not just for financial instruments that are CDs, but for any fixed income or fixed rate investment such as, but not limited to, bonds, using the methods and systems described herein. The data retrieval portion 302 may obtain the modified input parameters and securities data from the database 105. For example, in at least one embodiment the data retrieval portion 302 may obtain the modified “cdpricing-input.txt” file from the database 105. The data retrieval portion 302 may also obtain the modified model assumptions data from the database 105.

Control may then proceed to 1340 at which the valuation portion 301 may calculate the pricing values. In particular, the valuation portion 301 may execute a sequence of programmed instructions performing the price modeling calculations as described herein. For example, the valuation portion 301 may execute a sequence of programmed instructions to calculate an Option Adjusted Spread (OAS) using equations conforming to the Black-Karasinski model as discussed earlier herein. In particular, in at least one embodiment, a tetranomial lattice model employing the Black-Karasinski interest rate process and a recursive valuation procedure may be used to value one or more financial instruments, such as, but not limited to, option-embedded CDs given various yield-curve shifts.

Control may then proceed to 1345, at which the user may be prompted to request output of detailed security pricing. In at least one embodiment, the user may request to view detailed security pricing data by selecting an associated hyperlink using a pointing device. Upon user selection of the “Security Detail Pricing” hyperlink, the communication/GUI portion 303 (see FIG. 3) may generate an interactive page containing the CD pricing outputs generated by the valuation portion 301 and output the interactive page to the user. Upon user request to view detailed data associated with a particular security, the communications/GUI portion 303 may generate an interactive page showing detailed pricing and assumptions data associated with the selected security. An example of a security detail pricing page 1500 provided in accordance with at least one embodiment is shown in FIGS. 15a and 15b. Referring to FIGS. 15a and 15b, the security detail pricing page 1500 may include a “Clear Securities” button 1505, a “Pricing Section” button 1510, a “Go to Outputs” button 1515, and a “Go to Security” button 1520. In at least one embodiment, the user may request to view security details by selecting the “Go to Security” button 1520. Selecting the “Go to Security” button 1520 may cause display of security details, while selecting the “Pricing Section” button 1510 may cause display of a final price value. User selection of the “Clear Securities” button 1505 may cause the investment valuation system 100 to reset the valuation system 100 and delete the investment specific information and investment market specific information as shown in FIGS. 15a and 15b. The security detail pricing page 1500 may further include a final price 1525 for the financial instrument.

Control may then proceed to 1350, at which the user may also be instructed to view a pricing summary report 1400 by selecting, for example, the “Go to Outputs” button 1515. In at least one embodiment, the investment valuation system 100 may cause the pricing summary report 1400 to be output upon the user selecting the “Go to Outputs” button 1515. The investment valuation system 100 may determine how many separate output reports 103 can be generated. The communication/GUI portion 303 may then output to the user (for example, using a corresponding field of an interactive page) how many outputs must run based on, for example, memory and processing bandwidth limitations of the equipment 190. In at least one embodiment, there may be several possible outputs; however, a user only needs to request the number of outputs indicated on the interactive page. Alternatively, one output may be sufficient to obtain the final pricing summary report 1400 information. In the example pricing summary report 1400 of FIG. 14, the user may run up to sixteen (16) different outputs 1405. The user may be instructed to request generation of the first output report 103 by selecting the “Output 1” icon or button 1405. The user may need to run output 1, 2, 3, etc. depending on the number of outputs indicated. After each output report 103 is complete, a message indicating “Output # Complete” on the pricing summary report 1400 on the banner may be displayed. A “Security Detail Pricing” page 1500 may then be displayed as shown, for example, in FIGS. 15a and 15b. Other information and interactive fields provided by FIG. 14 may be as described earlier with respect to FIG. 8.

The user may be instructed to repeat various processes at 1320 through 1350 until the user has completed the number of output reports 103 necessary. For example, if the banner on the Pricing Summary page indicates to a user “You need to only run Output 1 through 4.”, the user should run Outputs 1 through Output 4 inclusive. The communication/GUI portion 301 may display a red banner on the interactive page to indicate “Output 4 Complete” when the user has completed his tasks. Alternatively, the valuation portion 301 may automatically run the number of output reports 103 necessary.

Once the user has completed all data input, control may proceed to 1355 at which the user may be instructed to request generation of files containing the price output reports 103. In particular, the user may be instructed to select the “Go to Outputs” button 1515 provided in at least one embodiment. Upon display of the pricing summary page 1400 in response (reference FIG. 14), the user may select one of the output buttons 1405 or 1410. Upon user selection of an output button 1405 or 1410, the investment valuation module 300 (see FIG. 3) may complete the valuation process and to produce the associated output pages. In at least one embodiment, the output pages thus generated may include a “cdpricing-output.xls” file for display and a “cdpricing-output.prn” file for printing. The output pages may be stored using the database 105 (see FIG. 1). The process of generating the output pages may, in some embodiments, take approximately five minutes to complete. Examples of output pages are shown in FIGS. 16-18. Following generation of the output pages, all files may then be closed without saving changes to the files.

Control may then proceed to 1360, at which the process may end.

While the invention has been described with reference to the certain illustrated embodiments, the words which have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather extends to all equivalent structures, acts, and materials, such as are within the scope of the appended claims.

What is claimed is:

1. A financial instrument value modeling system to calculate the value of a financial instrument based on instrument-specific data and instrument market-specific data, comprising:
a processor configured to perform financial instrument valuation analysis based on the instrument-specific data and the instrument market-specific data;
a memory coupled to the processor and configured to store at least instructions accessed by the processor during financial instrument valuation analysis;
a system interface configured to optionally receive instrument market-specific data and provide the instrument-specific data to the processor prior to or during the financial instrument valuation analysis; and
a user interface configured to receive financial instrument-specific data and provide that data to the processor prior to or during the financial instrument valuation analysis and configured to optionally receive instrument market-specific data and provide the market-specific data to the processor prior to or during the instrument valuation analysis.

2. The system of claim 1, wherein the financial instrument is a certificate of deposit.

3. The system of claim 1, wherein the processor is further configured to perform valuation analysis using a recursive algorithm.

4. The system of claim 3, wherein the recursive algorithm includes the Black-Karcinski equations.

5. The system of claim 1, wherein the processor is further configured to produce at least one valuation report.

6. A certificate of deposit value modeling method for calculating the current or future value of a certificate of deposit based on certificate-specific data and certificate market-specific data, the method comprising:
receiving certificate market-specific data either from a user interface or a system interface;
receiving certificate of deposit-specific data from a user interface;
performing certificate of deposit valuation analysis based on the certificate-specific data and the certificate market-specific data;
generating certificate of deposit valuation data based on the certificate of deposit valuation analysis; and
outputting the certificate of deposit valuation data via the user interface.

7. The method of claim 6, wherein performing certificate of deposit valuation analysis includes using a recursive algorithm.

8. The method of claim 6, wherein the recursive algorithm includes the Black-Karcinski equations.

9. The method of claim 6, wherein the outputting further includes producing at least. one valuation report.

10. A fixed rate investment valuation system, comprising:
a computing system including a processor;
wherein the processor is configured to determine a market value for at least one fixed rate investment based on instrument-specific data and market-specific data;
the computing system further including a user interface, wherein the processor is further configured to receive the instrument-specific data and the market-specific data input by a user via the user interface; and
wherein the processor is configured to output at least one valuation report including the determined market value.

11. The fixed rate investment valuation system of claim 10, the system further comprising a database operably coupled to the computing system, the database configured to store the instrument-specific data and the market-specific data.

12. The fixed rate investment valuation system of claim 11, the system further comprising a database server coupled to the database and to the computing system to store and retrieve the instrument-specific data and the market-specific data maintained using the database.

13. The fixed rate investment valuation system of claim 10, wherein the computing system further includes a system interface, wherein the processor is further configured to receive the instrument-specific data and the market-specific data from an external reporting service via the system interface.

14. A fixed rate investment valuation system, comprising:
a computing system including a processor, wherein the computing system is coupled to at least one terminal via a network;
the computing system further including a user interface, a client portion of which is downloaded to the terminal via the network upon receiving a request from a user at the terminal, the processor being further configured to receive the instrument-specific data and the market-specific data input by a user via the user interface client portion;
wherein the processor is configured to determine a market value for at least one fixed rate investment based on instrument-specific data and market-specific data; and
wherein the processor is configured to output to the terminal at least one valuation report including the determined market value.

15. The fixed rate investment valuation system of claim 14, the system further comprising a database operably coupled to the computing system, the database configured to store the instrument-specific data and the market-specific data.

16. The fixed rate investment valuation system of claim 15, the system further comprising a database server coupled to the database and to the computing system to store and retrieve the instrument-specific data and the market-specific data maintained using the database.

17. The fixed rate investment valuation system of claim 13, wherein the computing system further includes a system interface, wherein the processor is further configured to receive the instrument-specific data and the market-specific data from an external reporting service via the system interface.

18. A method of analyzing fixed rate investments, the method including:
receiving instrument-specific data;
receiving market-specific data;
determining a market value for a fixed rate investment using the instrument specific data and the market-specific data, the market value determination based on an option adjusted spread calculation;
generating at least one valuation report including the market value; and
outputting at least one of the valuation reports using a user interface of a computing system.

19. The method of analyzing fixed rate investments of claim 18, wherein the receiving of instrument specific data further comprises:
determining, for a fixed rate investment, an option adjustment spread, the option adjustment spread being expressed in terms of basis points;
determining an option call spread for the fixed rate investment, the option call spread being expressed in terms of basis points;
obtaining a reference yield curve for the fixed rate investment;
obtaining interest rate swap rate data for the fixed rate investment, the interest rate swap rate data including interest rate swap rate data for yields associated with the fixed rate investment if held for periods of differing durations;
obtaining a treasury yield curve for the fixed rate investment;
obtaining swaption mid-market volatility data for the fixed rate investment, the swaption mid-market volatility data arranged in a swaption mid-market volatility matrix;
obtaining investment callable spreads and fees for the fixed rate investment; and
storing, in a storage medium accessible by a processor, the option adjustment spread, the option call treasury yield curve, the swaption mid-market volatility data, and the investment callable spreads and fees.

20. The method of analyzing fixed rate investments of claim 19, wherein the receiving of instrument specific data further comprises accepting the instrument specific data from a user via a data entry device.

21. The method of analyzing fixed rate investments of claim 19, wherein the receiving of instrument specific data further comprises extracting the instrument specific data from one or more messages received via a network.

22. The method of analyzing fixed rate investments of claim 21, wherein the messages include live feed investment messages provided by an external reporting service.

23. The method of analyzing fixed rate investments of claim 19, the method further comprising:
storing the instrument specific data and market specific data in an input parameters file;
outputting one or more instructional displays containing instructions operable to allow a user to modify the instrument specific data and the market specific data contained in the input parameters file;
accepting user modifications, via data entry device, to the instrument specific data and the market specific data contained in the input parameters file; and
storing the modified instrument specific data and the market specific data in the input parameters file.

24. A computer-readable medium upon which is embodied a set of programmable instructions that when executed cause a processor to:
accept instrument-specific data;
accept market-specific data;
determine a market value for a fixed rate investment using the instrument specific data and the market-specific data, the market value determination based on an option adjusted spread calculation;
generate at least one valuation report including the market value; and
output at least one of the valuation reports using a user interface of a computing system.

25. The computer-readable medium of claim 24 upon which is embodied a further set of programmable instructions that when executed further cause a processor to:
determine, for a fixed rate investment, an option adjustment spread, the option adjustment spread being expressed in terms of basis points;
determine an option call spread for the fixed rate investment, the option call spread being expressed in terms of basis points;
obtain a reference yield curve for the fixed rate investment;
obtain interest rate swap rate data for the fixed rate investment, the interest rate swap rate data including interest rate swap rate data for yields associated with the fixed rate investment if held for periods of differing durations;
obtain a treasury yield curve for the fixed rate investment;
obtain swaption mid-market volatility data for the fixed rate investment, the swaption mid-market volatility data arranged in a swaption mid-market volatility matrix;
obtain investment callable spreads and fees for the fixed rate investment; and
store, in a storage medium accessible by a processor, the option adjustment spread, the option call treasury yield curve, the swaption mid-market volatility data, and the investment callable spreads and fees.
